(19) United States
(12) Patent Application Publication
(10) Pub. No.: US 2023/0068130 A1
(43) Pub. Date: Mar. 2, 2023

(54) Electrophotographic Photoreceptor, Electrophotographic Photoreceptor Cartridge, and Image Formation Device

(71) Applicant: Mitsubishi Chemical Corporation, Tokyo (JP)

(72) Inventors: Akira Ando, Tokyo (JP); Takahiro Choda, Tokyo (JP)

(73) Assignee: Mitsubishi Chemical Corporation, Tokyo (JP)

(21) Appl. No.: 17/950,818

(22) Filed: Sep. 22, 2022

Related U.S. Application Data
(63) Continuation of application No. PCT/JP2021/012110, filed on Mar. 24, 2021.

(30) Foreign Application Priority Data
Mar. 25, 2020 (JP) 2020-054603

(51) Int. Cl. G03G 5/147; G03G 5/06; G03G 5/05

(52) U.S. Cl. CPC G03G 5/14704; G03G 5/14734; G03G 5/0668; G03G 5/0677; G03G 5/067; G03G 5/0664; G03G 5/056

(57) ABSTRACT

In a positively charging single layer type electrophotographic photoreceptor having an over coat layer, an electrophotographic photoreceptor that is excellent in mechanical strength, electric characteristics, and adhesiveness, an electrophotographic photoreceptor cartridge, and an image formation device are provided. In a positively charging electrophotographic photoreceptor having a single layer type photosensitive layer and an over coat layer, the Martens hardness on the photoreceptor surface satisfies the prescribed condition, and preferably the photosensitive layer satisfies the particular relational expression of the contents and the molecular weights of the hole transporting substance and the electron transporting substance contained therein, thereby solving the problem.

### TECHNICAL FIELD

The present invention relates to an electrophotographic photoreceptor used in duplicators, printers, and the like, and an image formation device. Specifically, the present invention relates to a single layer type electrophotographic photoreceptor that is excellent in electric characteristics, mechanical characteristics, and adhesiveness, and an image formation device including the photoreceptor.

### BACKGROUND ART

The electrophotography can produce images with high quality in high speed, and therefore has been widely used in the fields including duplicators, printers, multifunction peripherals, and digital printing. An electrophotographic photoreceptor (which may be hereinafter referred simply to as a “photoreceptor”) as the core part of the electrophotography used has been a photoreceptor that uses an organic photoconductive substance having such advantages as no pollution, easiness in film formation, and easiness in production.

The known organic electrophotographic photoreceptors include, from the standpoint of the layer structure, a single layer type electrophotographic photoreceptor having a charge generating substance and a charge transporting substance in one layer (which may be hereinafter referred to as a “single layer type photoreceptor”), and a laminate type electrophotographic photoreceptor having a charge generating substance and a charge transporting substance that are separated in different layers and laminated (i.e., a charge generating layer and a charge transporting layer) (which may be hereinafter referred to as a “laminate type photoreceptor”).

Between these, the laminate type photoreceptor can be easily optimized for the functions of each layer from the standpoint of the design of the photoreceptor, and can be easily controlled for the characteristics thereof, and therefore most of the current photoreceptor are this type. Most of the laminate type photoreceptors have a charge generating layer and a charge transporting layer in this order on a substrate. In the charge transporting layer, there are significantly less kinds of favorable electron transporting substances, whereas many materials having good characteristics as the hole transporting substance have been known. Accordingly, the laminate type photoreceptor generally has a charge generating layer and a charge transporting layer in this order on a substrate, and is used by a negative charge system in which the photoreceptor surface is negatively charged. In the negative charge system, the amount of ozone generated from the charging unit is larger than the positive charge system in which the photoreceptor surface is positively charged, and thereby the deterioration of the photoreceptor therewith may be a problem in some cases.

On the other hand, the single layer type photoreceptor may be used in any of the negative charge system and the positive charge system in principle, but is advantageously applied to the positive charge system since the amount of ozone generated to cause a problem in the laminate type photoreceptor can be suppressed, and a higher sensitivity than the negative charge system can be generally obtained. Furthermore, the single layer type photoreceptor requires less coating steps, and has an advantage in resolution, and accordingly the single layer type photoreceptor has been partly put to practical use, and has been variously investigated and improved up to the present date, although the electric characteristics thereof have some inferior points to the negatively charged laminate type photoreceptor (see Patent Literatures 1 and 2).

The electrophotographic photoreceptor is applied repeatedly to an electrophotographic process, i.e., a cycle of charge, exposure, development, transfer, cleaning, destaticizing, and the like, and therefore is deteriorated by receiving various stress during the process. In particular, a damage due to mechanical deterioration, such as abrasion on the surface of the photosensitive layer, occurrence of flaws, and detachment of the film, caused by rubbing with the cleaning blade, the magnetic brush, or the like, the contact with the developer, the paper, or the like, readily appears on images to deteriorate directly the image quality, and thus is a large factor restricting the lifetime of the photoreceptor.

The known techniques of improving the mechanical strength or the abrasion resistance of the photoreceptor surface include a photoreceptor obtained in such a manner that a layer containing a compound having a chain polymerizable functional group as a binder resin is formed as the over coat layer of the photoreceptor, and is polymerized through application of energy, such as heat, light, and radiation, to form a cured resin layer (see, for example, Patent Literatures 3 and 4).

### CITATION LIST

### Patent Literatures

Patent Literature 1: JP 2001-33997 A

Patent Literature 2: JP 2005-331965 A

Patent Literature 3: U.S. Pat. No. 9,417,538 B

Patent Literature 4: WO 2010/035683 A1

### SUMMARY OF INVENTION

### Technical Problem

As described above, the positively charging single layer type photosensitive layer is inferior in electric characteristics to the negatively charging laminate type photoreceptor, but for improving the electric characteristics, the increase of the contents of the hole transporting substance and the electron transporting substance in the single layer type photosensitive layer has been considered effective.

However, the increase of the contents of the hole transporting substance and the electron transporting substance in the single layer type photosensitive layer relatively decreases the content of the binder resin, so as to cause a problem of deterioration of the mechanical strength of the photosensitive layer. Moreover, there is a tendency that the hole transporting substance and the electron transporting substance are concentrated to the surface of the photosensitive layer, and in the case where the over coat layer containing the cured resin is formed, the adhesiveness between the over coat layer and the photosensitive layer in contact therewith is significantly deteriorated. Consequently, the over coat layer drops off due to the stress caused by rubbing with the members disposed in contact with the photoreceptor in the electrophotographic process, such as the charging roller, the developing roller, the transfer roller, and the cleaning blade, or the printing paper, resulting in a problem of deterioration in mechanical strength.

The present invention has been made in view of the problems described above. Specifically, an object of the present invention is to provide a positively charging single layer type electrophotographic photoreceptor that is excellent in electric characteristics and mechanical characteristics, and is excellent in adhesiveness between the photosensitive layer and the over coat layer, and an electrophotographic photoreceptor cartridge and an image formation device using the electrophotographic photoreceptor.

### Solution to Problem

As a result of earnest investigations on an electrophotographic photoreceptor that satisfies the object by the present inventors, it has been found that the problem can be solved by a positively charging single layer type photoreceptor having an over coat layer containing a cured resin in which the Martens hardness of the photoreceptor surface satisfies the prescribed condition, and thus the present invention has been completed.

Furthermore, even though the contents of the hole transporting substance and the electron transporting substance in the photosensitive layer are increased, the problem can be solved by which the contents and the molecular weights of the hole transporting substance and the electron transporting substance satisfy the particular relational expression, and the Martens hardness of the photoreceptor surface satisfies the prescribed condition, and thus the present invention has been completed.

The substance of the present invention resides in the following items [1] to [14].

[1] A positively charging electrophotographic photoreceptor including a conductive support having thereon at least a photosensitive layer and an over coat layer, the photosensitive layer being a single layer containing at least a binder resin, a charge generating substance, a hole transporting substance, and an electron transporting substance, the over coat layer having a structure formed through polymerization of a compound having a chain polymerizable functional group, the photoreceptor having a surface having a Martens hardness of 345 N/mm² or more.

[2] The electrophotographic photoreceptor according to the item [1], wherein the photosensitive layer satisfies the following expression (1):

0.9≤(B/b)/(A/a)≤4.0 (1)

wherein in the expression (1), A represents a content (part by mass) of the hole transporting substance per a content of 100 of the binder resin; a represents a molecular weight of the hole transporting substance; B represents a content (part by mass) of the electron transporting substance per a content of 100 of the binder resin; and b represents a molecular weight of the electron transporting substance.

[3] The electrophotographic photoreceptor according to the item [1] or [2], wherein the photosensitive layer satisfies the following expression (2):

0.15≤(A/a)+(B/b) (2)

wherein in the expression (2), A represents a content (part by mass) of the hole transporting substance per a content of 100 of the binder resin; a represents a molecular weight of the hole transporting substance; B represents a content (part by mass) of the electron transporting substance per a content of 100 of the binder resin; and b represents a molecular weight of the electron transporting substance.

[4] A positively charging electrophotographic photoreceptor including a conductive support having thereon at least a photosensitive layer and an over coat layer, the photosensitive layer being a single layer containing at least a binder resin, a charge generating substance, a hole transporting substance, and an electron transporting substance, the photosensitive layer satisfying the following expression (1) and the following expression (2), the over coat layer having a structure formed through polymerization of a compound having a chain polymerizable functional group, the photoreceptor having a surface having a Martens hardness of 350 N/mm² or more:

0.9≤(B/b)/(A/a)≤4.0 (1)

0.15≤(A/a)+(B/b) (2)

wherein in the expression (1) and the expression (2), A represents a content (part by mass) of the hole transporting substance per a content of 100 of the binder resin; a represents a molecular weight of the hole transporting substance; B represents a content (part by mass) of the electron transporting substance per a content of 100 of the binder resin; and b represents a molecular weight of the electron transporting substance.

[5] The electrophotographic photoreceptor according to any one of the items [1] to [4], wherein the over coat layer contains metal oxide fine particles.

[6] The electrophotographic photoreceptor according to the item [5], wherein the metal oxide fine particles are surface-treated with a surface treatment agent having a polymerizable functional group.

[7] The electrophotographic photoreceptor according to any one of the items [1] to [6], wherein the photosensitive layer contains the hole transporting substance having a molecular weight of 700 or more.

[8] The electrophotographic photoreceptor according to any one of the items [1] to [7], wherein the compound having a chain polymerizable functional group contains a compound having two or more chain polymerizable functional groups.

[9] The electrophotographic photoreceptor according to any one of the items [1] to [8], wherein the compound having a chain polymerizable functional group contains a compound having an acryloyl group or a methacryloyl group.

[10] The electrophotographic photoreceptor according to any one of the items [1] to [9], wherein the compound having a chain polymerizable functional group contains a urethane acrylate.

[11] The electrophotographic photoreceptor according to any one of the items [1] to [10], wherein the photosensitive layer contains the electron transporting substance having a molecular weight of 400 or more.

[12] The electrophotographic photoreceptor according to any one of the items [1] to [11], wherein the electron transporting substance contained in the photosensitive layer has a structure represented by the following formula (6):

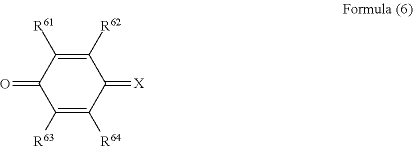

wherein in the formula (6), R⁶¹ to R⁶⁴ each independently represent a hydrogen atom, an alkyl group having 1 or more and 20 or less carbon atoms, which may be substituted, or an alkenyl group having 2 or more and 20 or less carbon atoms, which may be substituted, R⁶¹ and R⁶², or R⁶³ and R⁶⁴ may be bonded to each other to form a cyclic structure; and X represents an organic residual group having a molecular weight of 120 or more and 250 or less.

[13] An electrophotographic photoreceptor cartridge including the electrophotographic photoreceptor according to any one of the items [1] to [12].

[14] An image formation device including the electrophotographic photoreceptor according to any one of the items [1] to [12].

### Advantageous Effects of Invention

According to the present invention, a positively charging single layer type electrophotographic photoreceptor that is excellent in electric characteristics and mechanical characteristics, and is excellent in adhesiveness, and an electrophotographic photoreceptor cartridge and an image formation device using the electrophotographic photoreceptor can be provided.

### BRIEF DESCRIPTION OF DRAWING

FIG. 1 is a graph showing the load curve with respect to the indentation depth of the indenter in the measurement of the Martens hardness of the photoreceptor surface.

### DESCRIPTION OF EMBODIMENTS

### Electrophotographic Photoreceptor

The electrophotographic photoreceptor of the present invention has, on a surface of a conductive support, a single layer type photosensitive layer having a binder resin, a charge generating substance, a hole transporting substance, and an electron transporting substance in the same layer, and an over coat layer having a structure formed through polymerization of a compound having a chain polymerizable functional group.

The components constituting the electrophotographic photoreceptor of the present invention (i.e., the conductive support, the single layer type photosensitive layer, and the over coat layer) will be described below.

### Conductive Support

The conductive support used in the photoreceptor of the present invention will be described.

The conductive support is not particularly limited, as far as that the single layer type photosensitive layer and the over coat layer described later can be supported thereby, and conductivity is exhibited thereby. Examples of the conductive support mainly used include a metal material or a metal, such as aluminum, an aluminum alloy, a stainless steel, copper, and nickel, a resin material having conductivity imparted with co-existing conductive powder, such as carbon and tin oxide, and a resin, glass, paper, or the like having vapor-deposited or coated on the surface thereof a conductive material, such as aluminum, nickel, and ITO (indium oxide-tin oxide alloy).

The form thereof used may be a drum form, a sheet form, a belt form, or the like. A conductive support formed of a metal material having coated thereon a conductive material having a suitable resistance value for controlling the conductivity and the surface property or for covering defects may also be used.

In the case where a metal material, such as an aluminum alloy, is used as the conductive support, the metal material may be used after forming an anodized film thereon.

The average film thickness of the anodized film is generally 20 μm or less, and is particularly preferably 7 μm or less.

The surface of the conductive support may be smooth, or may be roughed by using a particular cutting method or by subjecting to an abrasive treatment. The surface thereof may also be roughened by mixing particles having a suitable particle diameter in the material constituting the support.

An undercoating layer described later may be provided between the conductive support and the photosensitive layer for improving the adhesiveness, the blocking capability, and the like.

### Single Layer Type Photosensitive Layer

The materials used in the single layer type photosensitive layer (such as the charge generating substance, the hole transporting substance, the electron transporting substance, and the binder resin) will be described below.

### Charge Generating Substance

Examples of the charge generating substance used in the photosensitive layer include various photoconductive materials, for example, an inorganic photoconductive material, such as selenium and an alloy thereof, and cadmium sulfide and other inorganic photoconductive materials; and an organic pigment, such as a phthalocyanine pigment, an azo pigment, a quinacridone pigment, an indigo pigment, a perylene pigment, a polycyclic quinone pigment, an anthanthrone pigment, and a benzimidazole pigment. Among these, an organic pigment is preferred, and a phthalocyanine pigment and an azo pigment are more preferred.

In particular, in the case where a phthalocyanine pigment is used as the charge generating substance, specific examples thereof used include metal-free phthalocyanine and a phthalocyanine compound having coordinated thereto a metal, such as copper, indium, gallium, tin, titanium, zinc, vanadium, silicon, and germanium, and oxides and halides thereof. Examples of the ligand for a trivalent or higher valent metal atom include an oxygen atom and a chlorine atom described above, and also include a hydroxy group and an alkoxy group. Among these, X-type or τ-type metal-free phthalocyanine, A-type, B-type, D-type, and the like titanyl phthalocyanine, vanadyl phthalocyanine, chloro indium phthalocyanine, chloro gallium phthalocyanine, hydroxy gallium phthalocyanine, and the like, which have high sensitivity, are preferred.

Among the crystal forms of titanyl phthalocyanine described above, the A-type and the B-type are shown as the I-phase and the II-phase, respectively, by W. Heller, et al. (Zeit. Kristallogr. 159 (1982) 173), and the A-type is known as a stable type. The D-type is a crystal form characterized by showing a clear peak at 27.3° of diffraction angle 2θ±0.2° in powder X-ray diffraction using the CuKα line.

In the case where an azo pigment is used, various known bisazo pigments and trisazo pigments are preferably used. Preferred examples of the azo pigment are shown below.

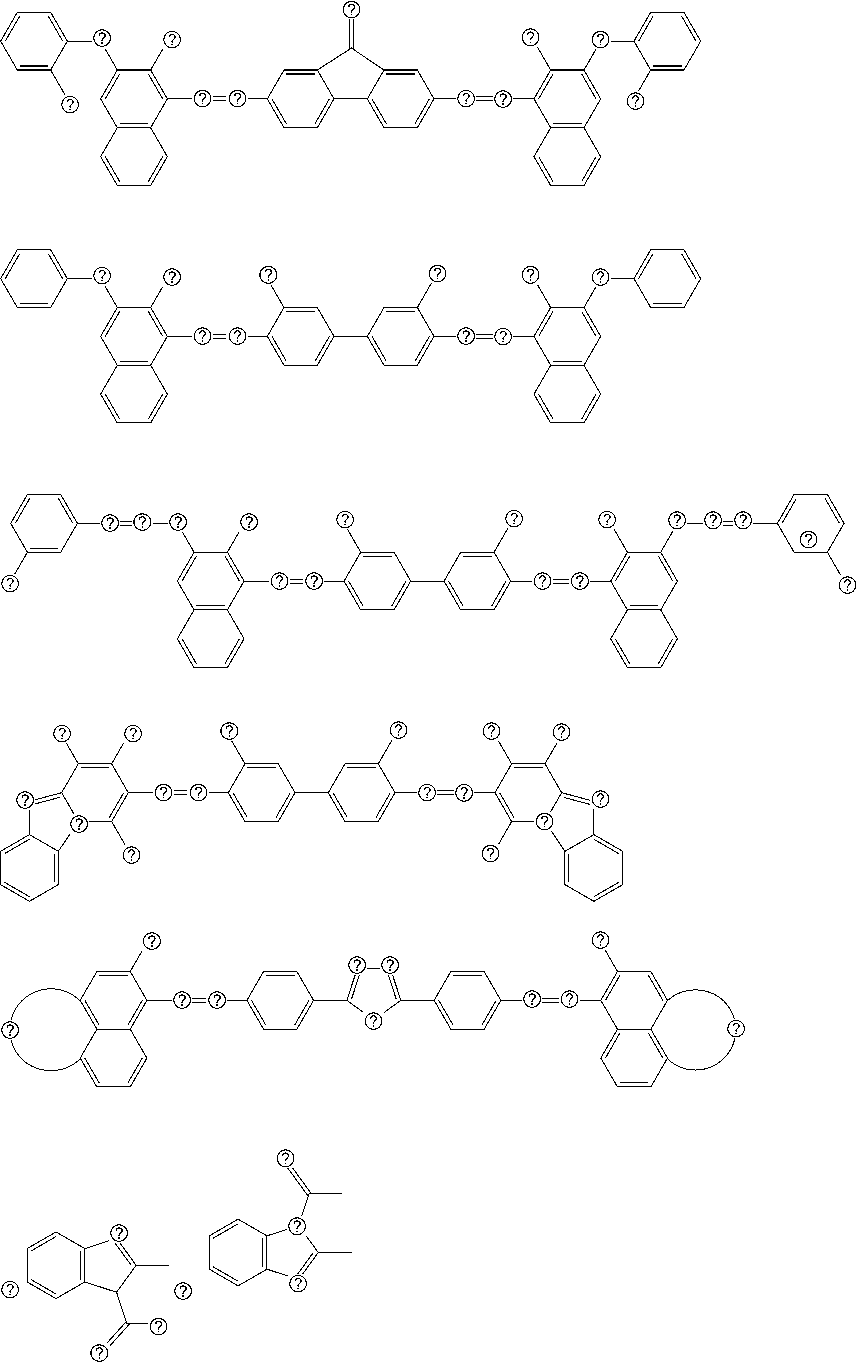

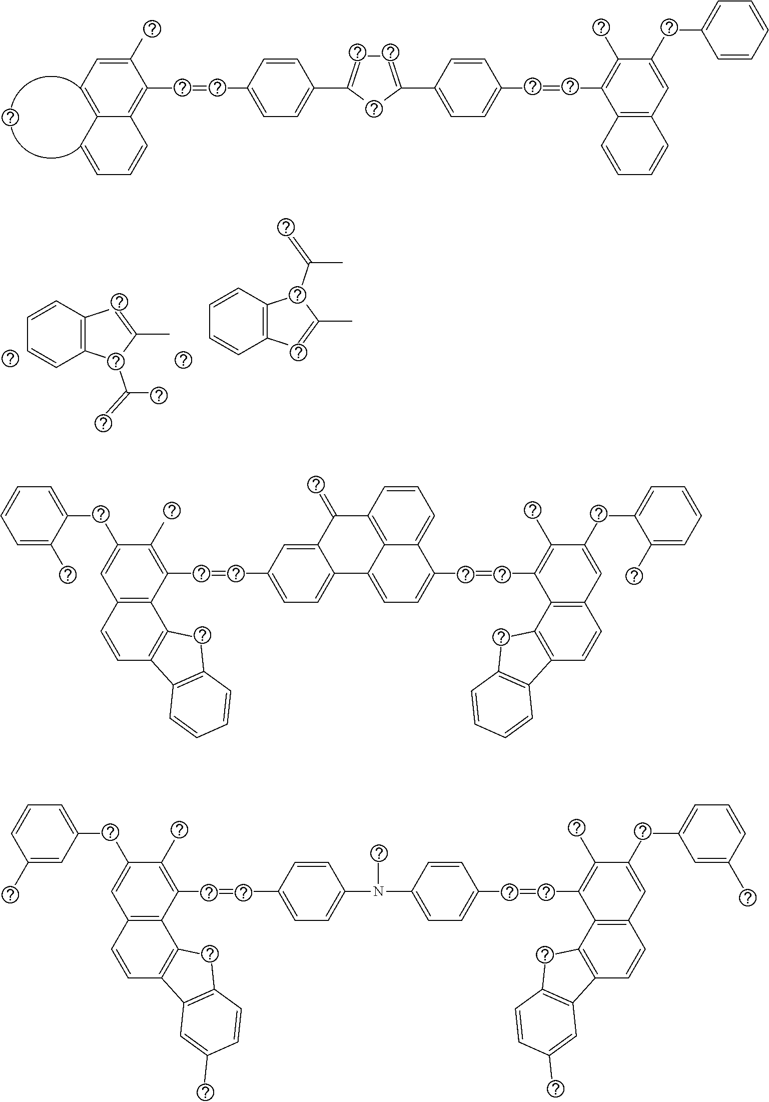

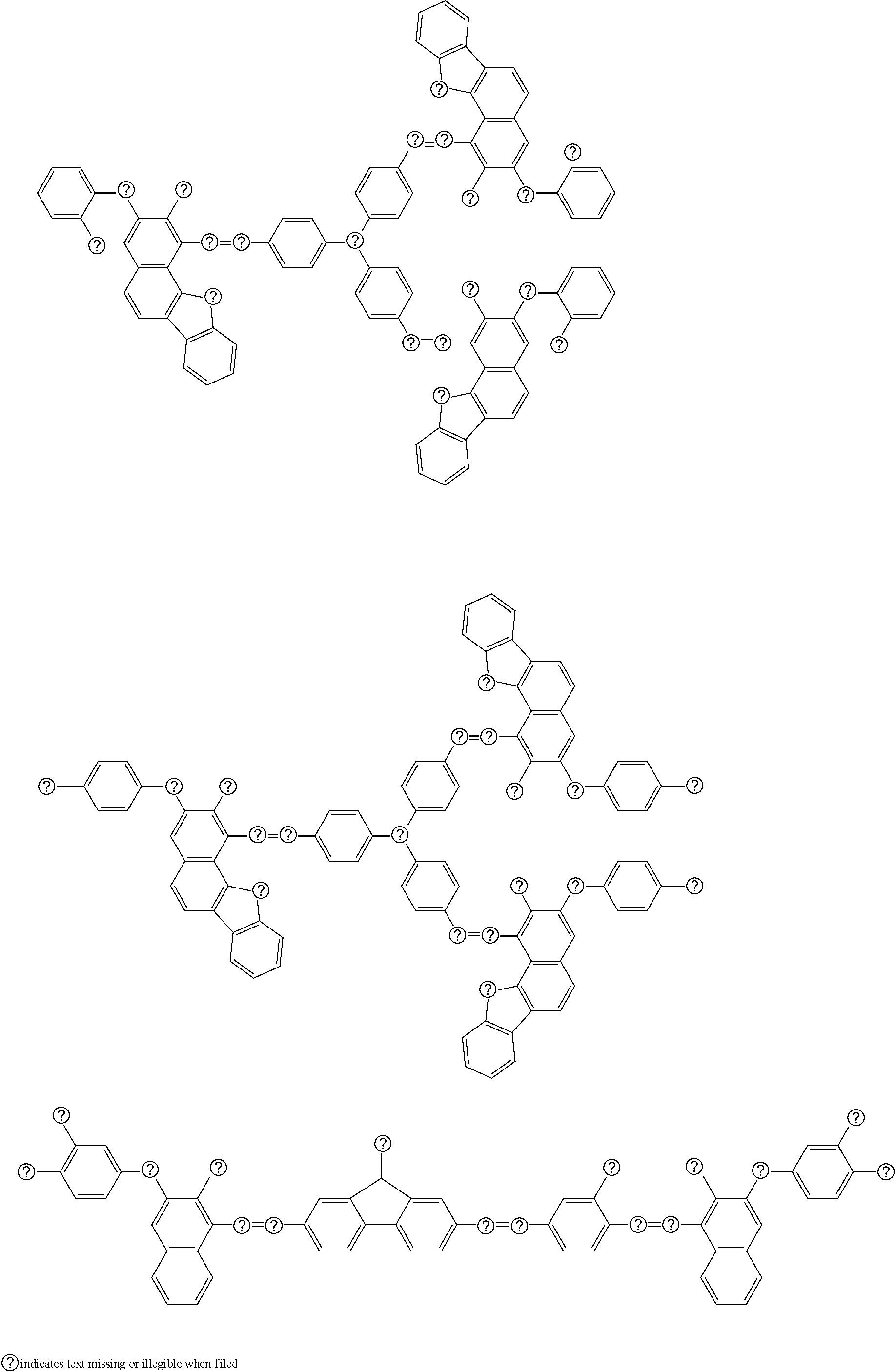

One kind of the charge generating substance may be used alone, or two or more kinds thereof may be used as an optional combination at an optional ratio. In the case where two or more kinds of the charge generating substances are used in combination, the mixing method of the charge generating substances used in combination may be a method of mixing the charge generating substances later, or a method of mixing them in the production or treatment process of the charge generating substances, such as synthesis, formation of pigment, and crystallization. Examples of the known treatment of this type include an acid pasting treatment, a grinding treatment, and a solvent treatment.

The particle diameter of the charge generating substance is preferably small. Specifically, the particle diameter thereof is generally preferably 1 μm or less, and more preferably 0.5 μm or less.

The amount of the charge generating substance in the single layer type photosensitive layer is generally preferably 0.1% by mass or more, and more preferably 0.5% by mass or more, from the standpoint of the sensitivity. The amount thereof is generally preferably 50% by mass or less, and more preferably 20% by mass or less, from the standpoint of the sensitivity and the chargeability.

### Charge Transporting Substance

The charge transporting substance is classified into a hole transporting substance mainly having a hole transporting capability and an electron transporting substance mainly having an electron transporting capability. The single layer type photosensitive layer used in the present invention contains both the hole transporting substance and the electron transporting substance.

[Hole Transporting Substance] The hole transporting substance may be any known material with no particular limitation, and examples thereof include an electron donating substance, for example, a heterocyclic compound, such as a carbazole derivative, an indole derivative, an imidazole derivative, an oxazole derivative, a pyrazole derivative, a thiadiazole derivative, and an benzofuran derivative, and an aniline derivative, a hydrazone derivative, an arylamine derivative, a stilbene derivative, a butadiene derivative, and an enamine derivative, and a combination of multiple kinds of these compounds bonded to each other, and a polymer having a group formed of any of these compounds on the main chain or the side chain thereof.

Among these, a carbazole derivative, an arylamine derivative, a stilbene derivative, a butadiene derivative, and an enamine derivative, and a combination of multiple kinds of these compounds bonded to each other are preferred, and an arylamine derivative and an enamine derivative are more preferred.

The hole transporting substance having a larger molecular weight tends to exhibit good electric characteristics due to the higher effect of delocalizing the received hole thereof. The hole transporting substance having a larger molecular weight is also advantageous from the standpoint of the adhesiveness to the over coat layer due to the low migration thereof to the surface. From this standpoint, the molecular weight of the hole transporting substance is preferably 350 or more, more preferably 450 or more, and further preferably 700 or more. From the standpoint of the solubility, the molecular weight thereof is preferably 1,500 or less, and more preferably 1,000 or less.

One kind of the hole transporting substance may be used alone, or two or more kinds thereof may be used as an optional combination at an optional ratio. In the case where two or more kinds of the hole transporting substances are used in combination, the hole transporting substances having a molecular weight of 700 or more are preferably used from the standpoint of the electric characteristics and the migration to the surface described above. It is further preferred that among the two or more kinds of the hole transporting substances contained in the photosensitive layer, the molecular weight of the hole transporting substance having the maximum content (part by mass) in the photosensitive layer is 700 or more.

Preferred examples of the hole transporting substance are shown below.

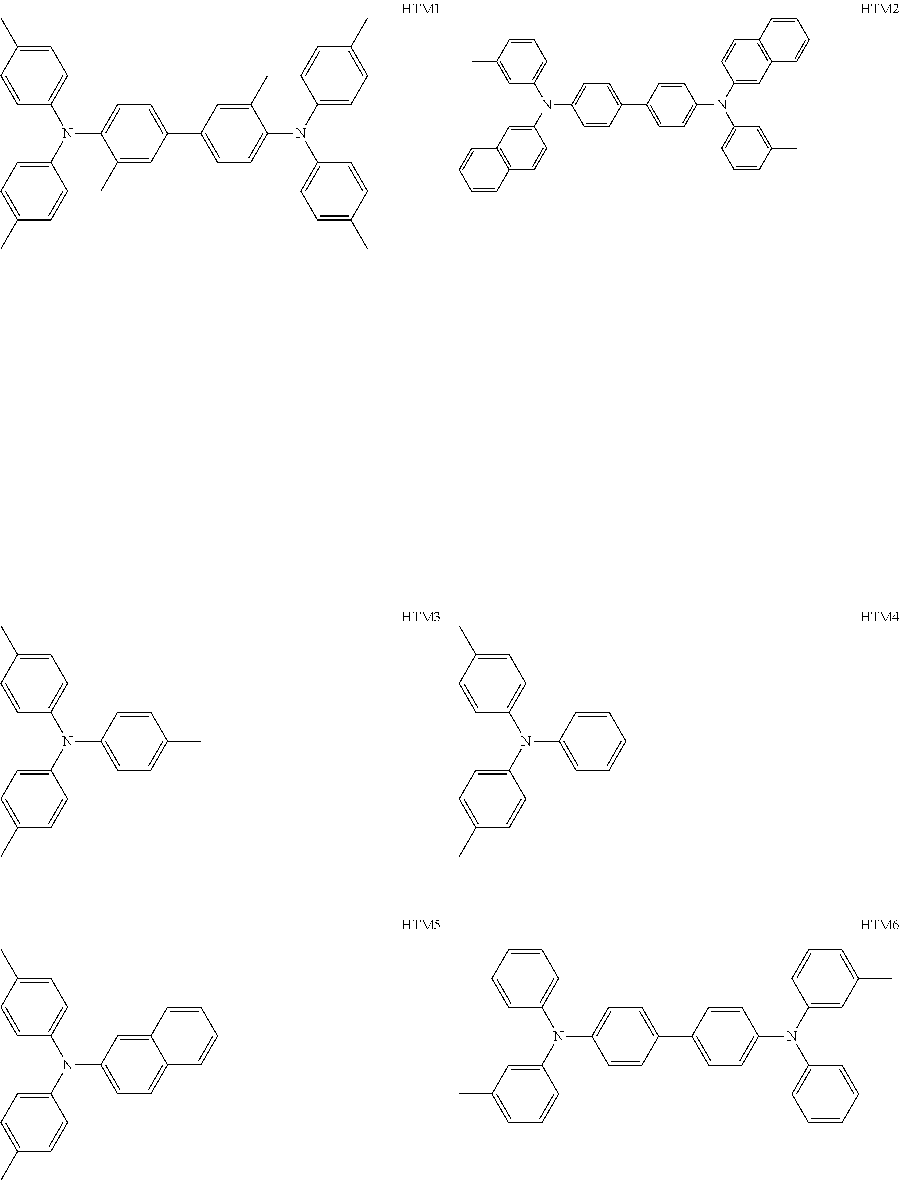

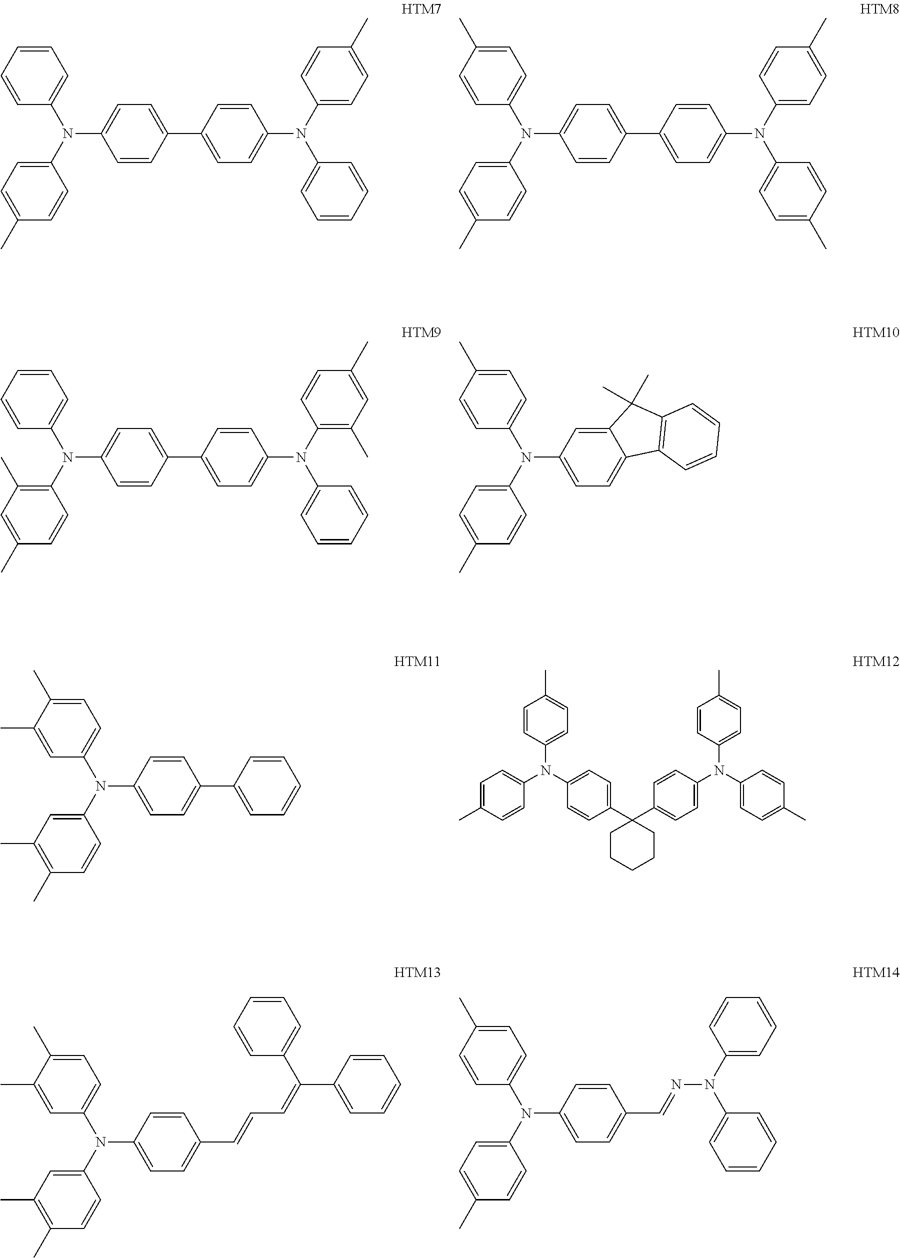

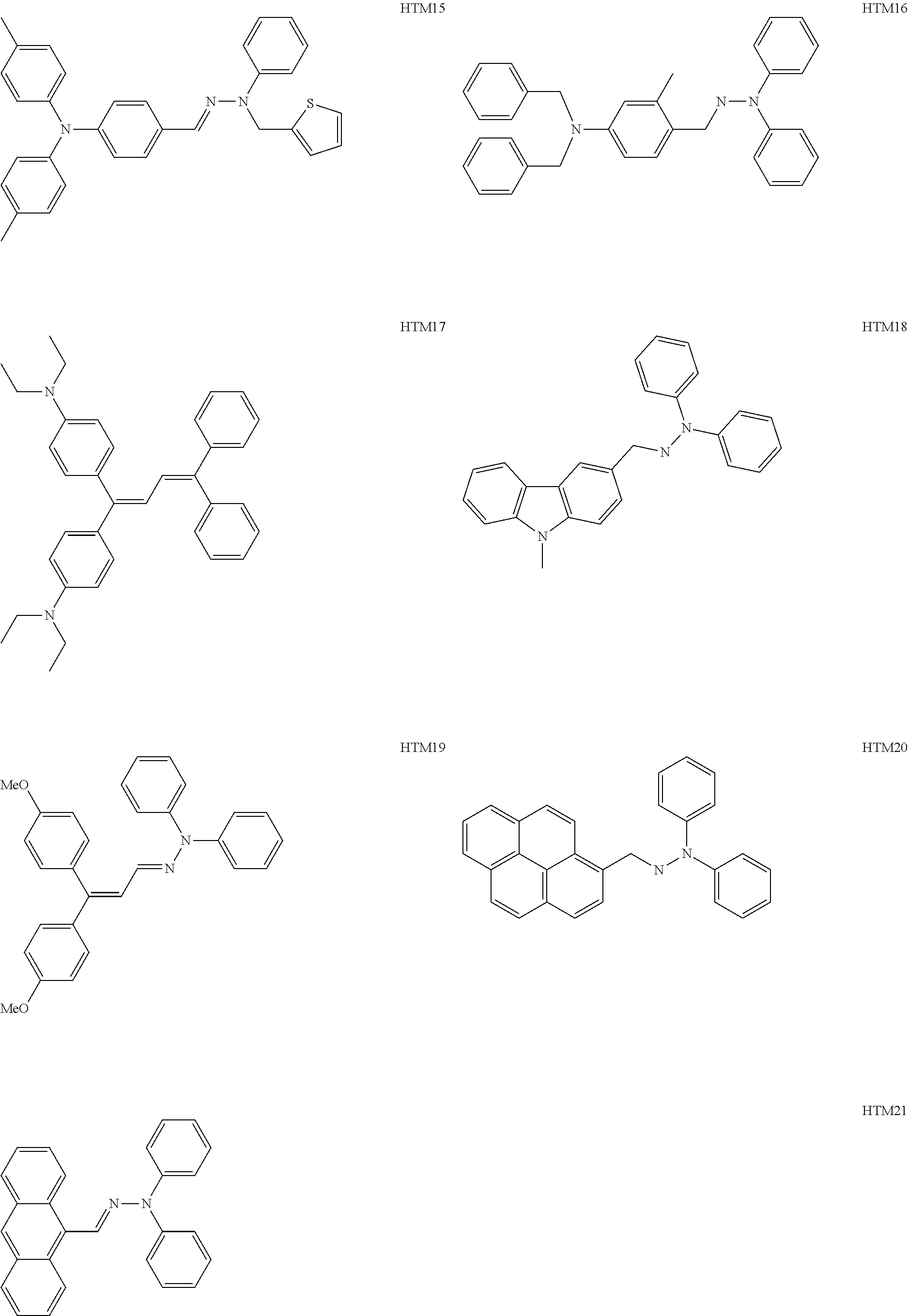

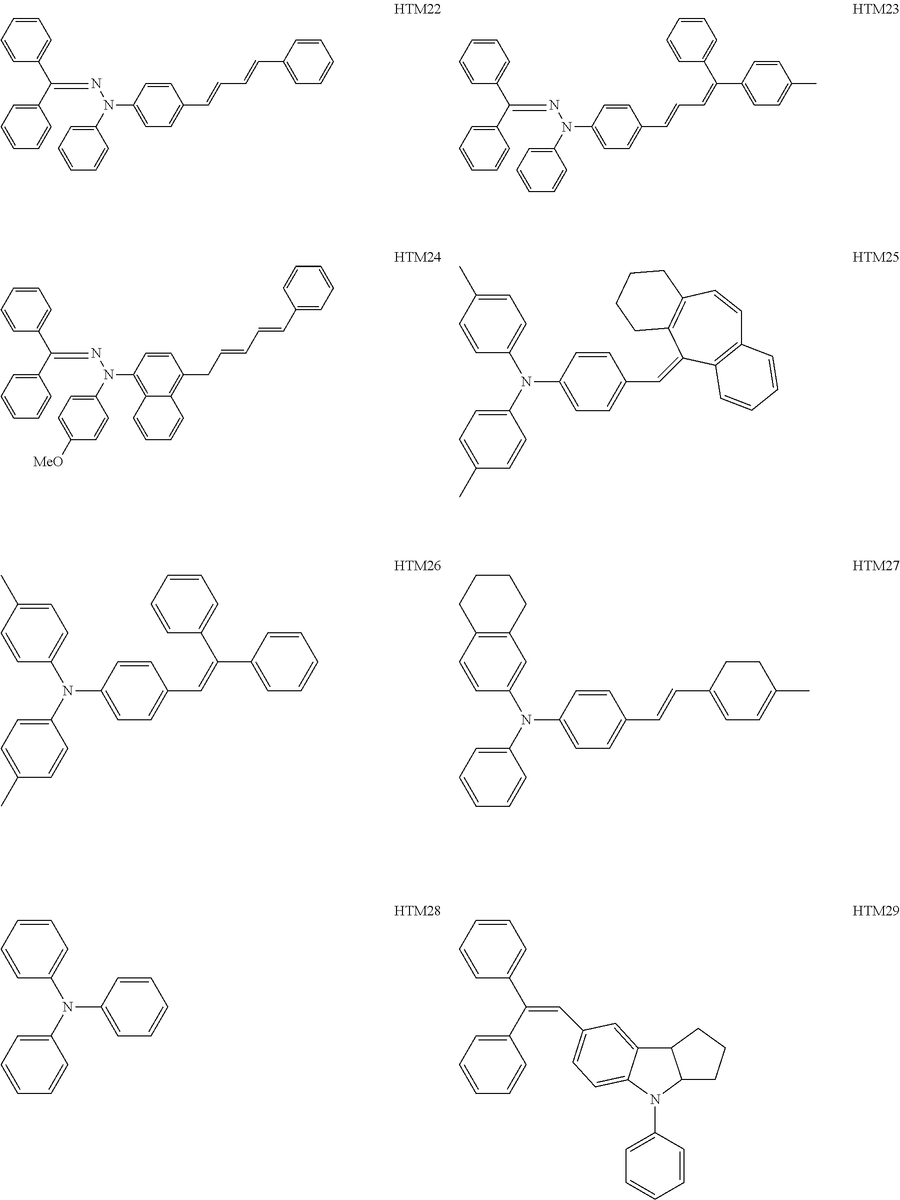

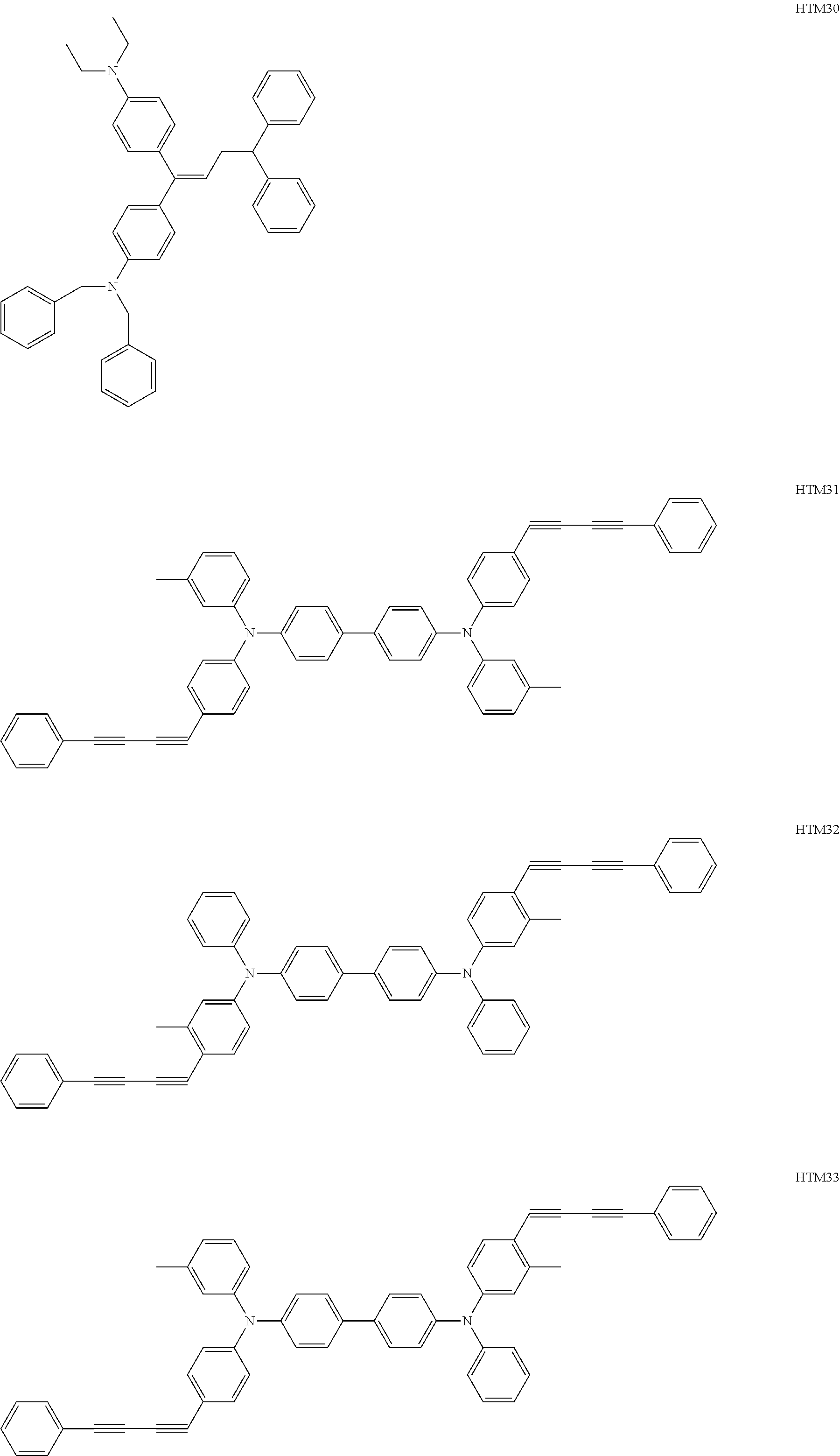 [SMILES: CCN(CC)c1ccc(/C(=C\CC(c2ccccc2)c2ccccc2)c2ccc(N(Cc3ccccc3)Cc3ccccc3)cc2)cc1 ; Cc1cccc(N(c2ccc(C#CC#Cc3ccccc3)cc2)c2ccc(-c3ccc(N(c4ccc(C#CC#Cc5ccccc5)cc4)c4cccc(C)c4)cc3)cc2)c1 ; Cc1cc(N(c2ccccc2)c2ccc(-c3ccc(N(c4ccccc4)c4ccc(C#CC#Cc5ccccc5)c(C)c4)cc3)cc2)ccc1C#CC#Cc1ccccc1 ; Cc1cccc(N(c2ccc(C#CC#Cc3ccccc3)cc2)c2ccc(-c3ccc(N(c4ccccc4)c4ccc(C#CC#Cc5ccccc5)c(C)c4)cc3)cc2)c1]

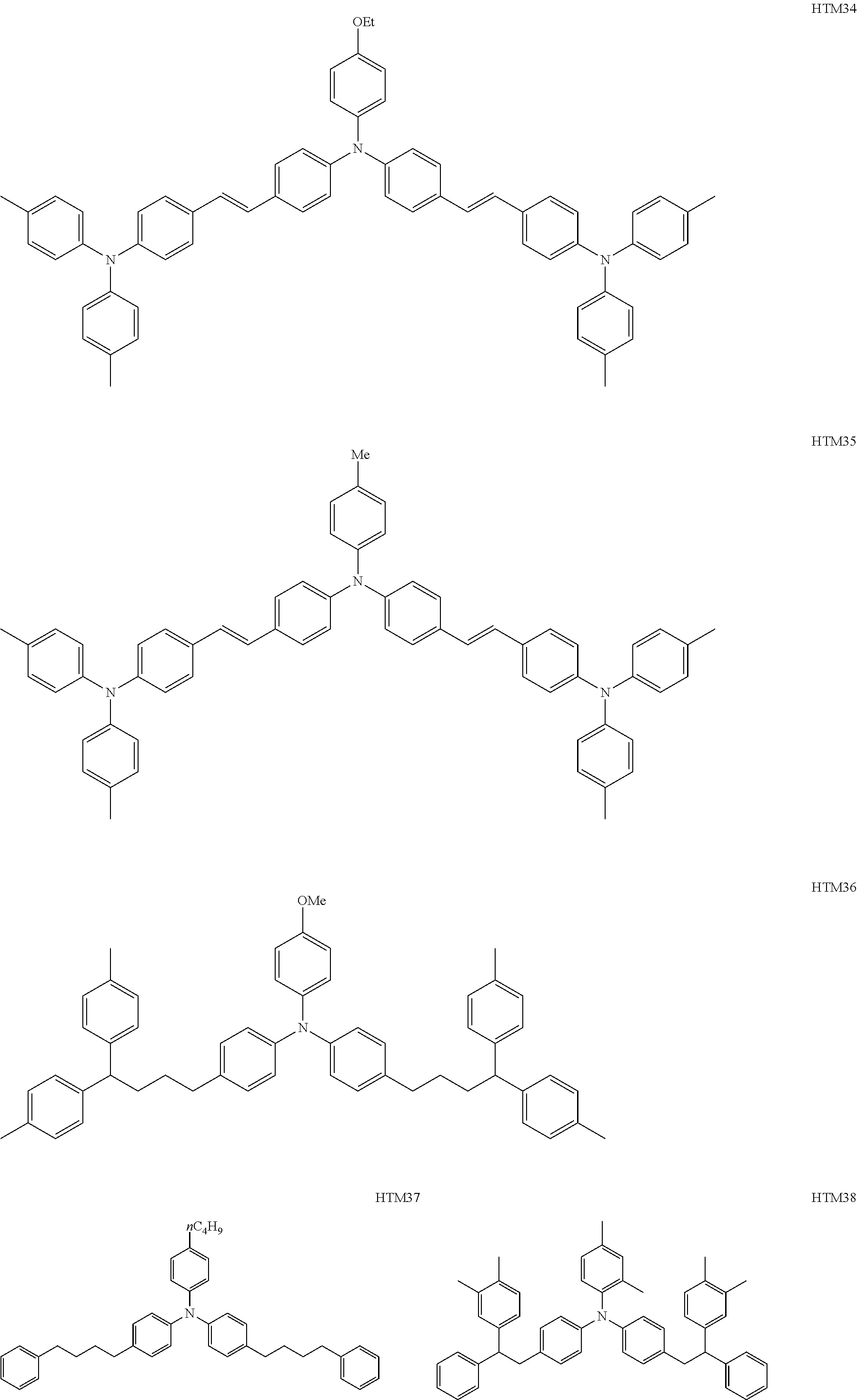

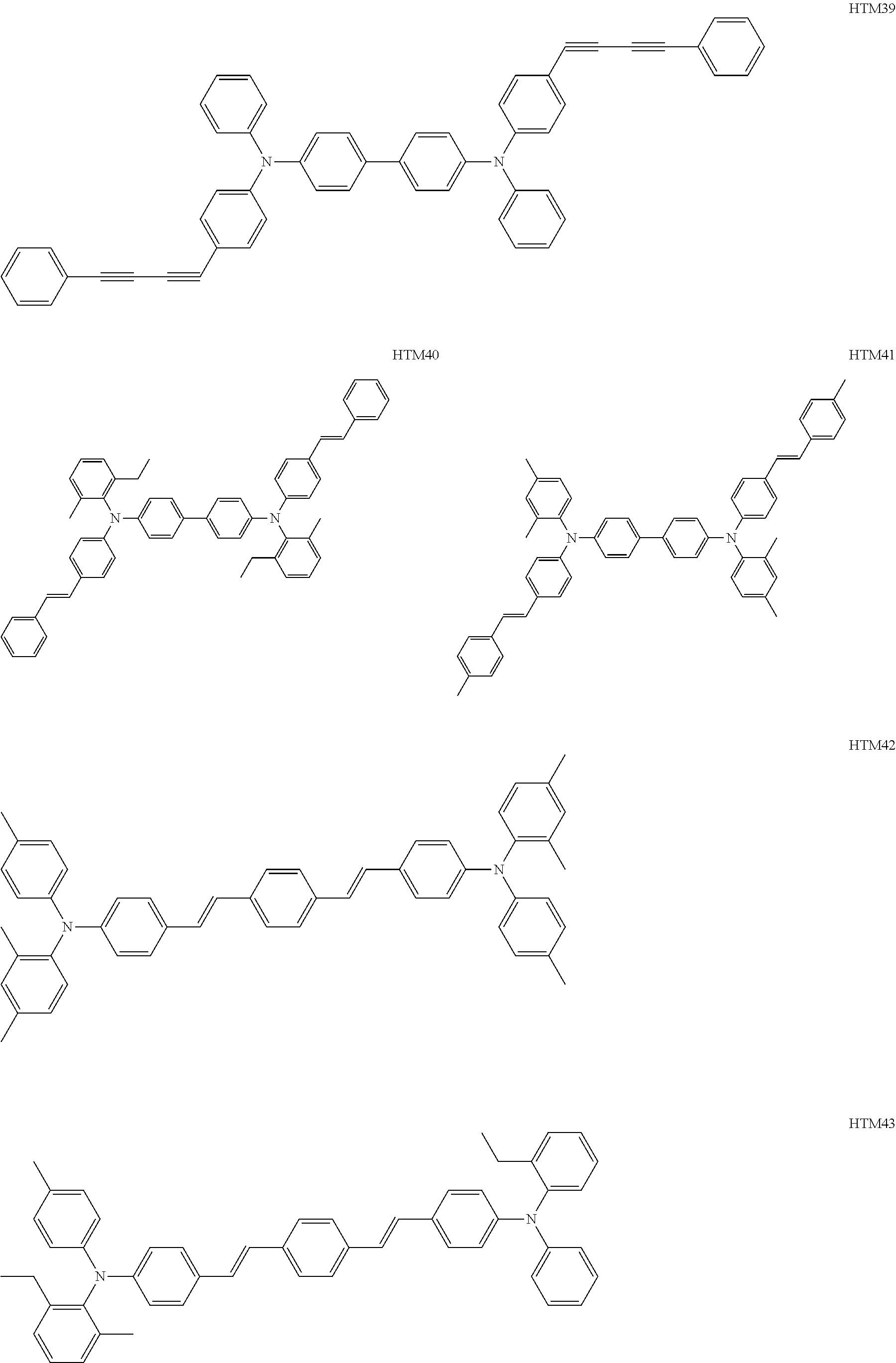

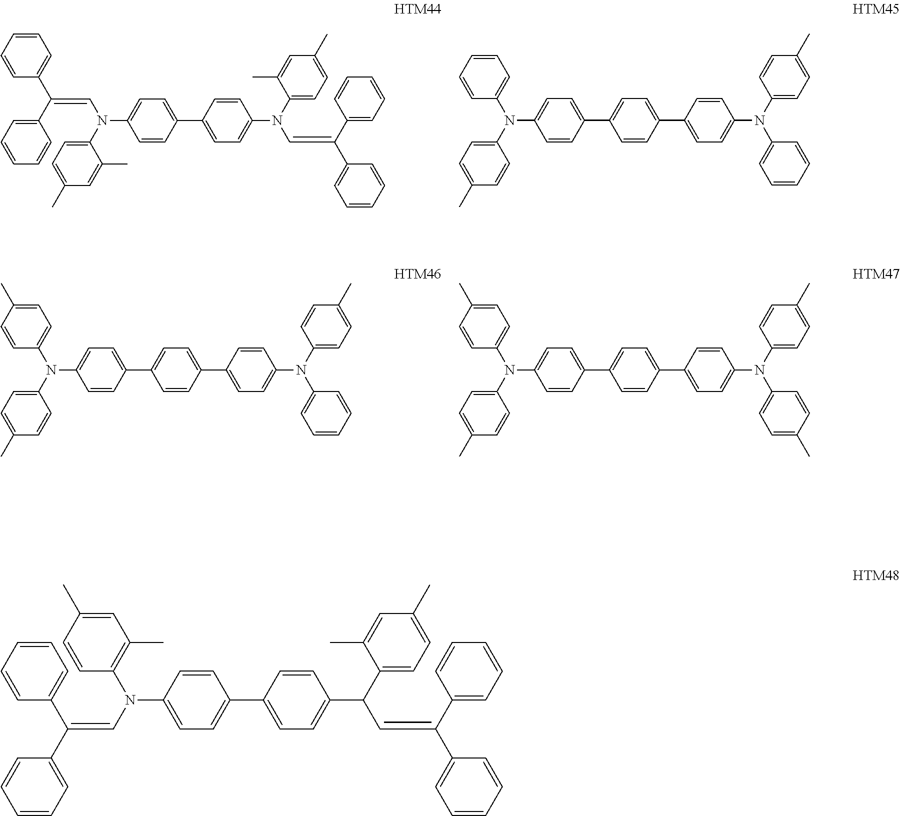 [SMILES: Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1 ; Cc1ccc(N(c2ccccc2)c2ccc(-c3ccc(-c4ccc(N(c5ccccc5)c5ccc(C)cc5)cc4)cc3)cc2)cc1 ; Cc1ccc(N(c2ccccc2)c2ccc(-c3ccc(-c4ccc(N(c5ccc(C)cc5)c5ccc(C)cc5)cc4)cc3)cc2)cc1 ; Cc1ccc(N(c2ccc(C)cc2)c2ccc(-c3ccc(-c4ccc(N(c5ccc(C)cc5)c5ccc(C)cc5)cc4)cc3)cc2)cc1 ; Cc1ccc(C(C=C(c2ccccc2)c2ccccc2)c2ccc(-c3ccc(N(C=C(c4ccccc4)c4ccccc4)c4ccc(C)cc4C)cc3)cc2)c(C)c1]

Among the hole transporting substances above, HTM6, HTM7, HTM8, HTM9, HTM10, HTM12, HTM14, HTM26, HTM31, HTM32, HTM33, HTM34, HTM35, HTM36, HTM37, HTM38, HTM39, HTM40, HTM41, HTM42, HTM43, and HTM48 are preferred, HTM31, HTM32, HTM33, HTM34, HTM35, HTM36, HTM37, HTM38, HTM39, HTM40, HTM41, HTM42, HTM43, and HTM48 are more preferred, and HTM39, HTM40, HTM41, HTM42, HTM43, and HTM48 are further preferred, from the standpoint of the electric characteristics.

[Electron Transporting Substance] The electron transporting substance may be any known material with no particular limitation, and examples thereof include an electron withdrawing substance, for example, an aromatic nitro compound, such as 2,4,7-trinitrofluorenone, a cyano compound, such as tetracyanoquinodimethane, and a quinone compound, such as diphenoquinone, and a known cyclic ketone compound and a known perylene pigment (perylene derivative). A compound represented by the following formula (6) is particularly preferred.

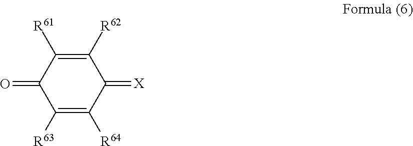

R⁶¹ to R⁶⁴ each independently represent a hydrogen atom, an alkyl group having 1 or more and 20 or less carbon atoms, which may be substituted, or an alkenyl group having 2 or more and 20 or less carbon atoms, which may be substituted.

Examples of the alkyl group having 1 or more and 20 or less carbon atoms, which may be substituted, include a linear alkyl group, a branched alkyl group, and a cyclic alkyl group, and a linear alkyl group and a branched alkyl group are preferred from the standpoint of the electron transporting capability. The number of carbon atoms of these alkyl groups is generally 1 or more, and preferably 4 or more, and is generally 20 or less, preferably 15 or less from the standpoint of the versatility of the raw material, more preferably 10 or less from the standpoint of the handleability in production, and further preferably 5 or less. Specific examples thereof include a methyl group, an ethyl group, a hexyl group, an isopropyl group, a tert-butyl group, a tert-amyl group, a cyclohexyl group, and a cyclopentyl group. Among these, a methyl group, a tert-butyl group, and a tert-amyl group are preferred, and a tert-butyl group and a tert-amyl group are more preferred from the standpoint of the solubility in an organic solvent used in a coating liquid.

Examples of the alkenyl group having 2 or more and 20 or less carbon atoms, which may be substituted, include a linear alkenyl group, a branched alkenyl group, and a cyclic alkenyl group. The number of carbon atoms of these alkenyl groups is generally 2 or more, and preferably 4 or more, and is generally 20 or less, and preferably 10 or less from the standpoint of the light attenuation characteristics of the photoreceptor. Specific examples thereof include an ethenyl group, a 2-methyl-1-propenyl group, and a cyclohexenyl group.

In the substituents R⁶¹ to R⁶⁴, R⁶¹ and R⁶², or R⁶³ and R⁶⁴ may be bonded to each other to form a cyclic structure. In the case where both R⁶¹ and R⁶² represent alkenyl groups, it is preferred that both the groups are bonded to each other to form an aromatic ring, and it is more preferred that both R⁶¹ and R⁶² represent ethenyl groups, and both the groups are bonded to each other to form a benzene ring structure, from the standpoint of the electron mobility.

In the formula (6), X represents an organic residual group having a molecular weight of 120 or more and 250 or less, and the compound represented by the formula (6) is preferably a compound represented by any one of the following formulae (7) to (10) from the standpoint of the light attenuation characteristics of the photoreceptor:

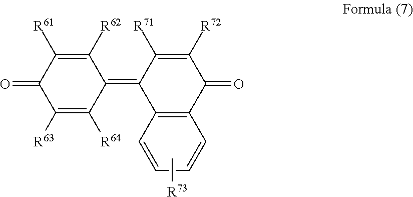

wherein in the formula (7), R⁷¹ to R⁷³ each independently represent a hydrogen atom, a halogen atom, or an alkyl group having 1 or more and 6 or less carbon atoms,

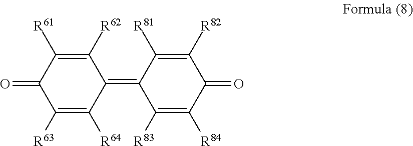

wherein in the formula (8), R⁸¹ to R⁸⁴ each independently represent a hydrogen atom, a halogen atom, or an alkyl group having 1 or more and 6 or less carbon atoms,

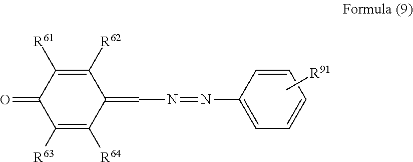

wherein in the formula (9), R⁹¹ represents a hydrogen atom, an alkyl group having 1 or more and 6 or less carbon atoms, or a halogen atom,

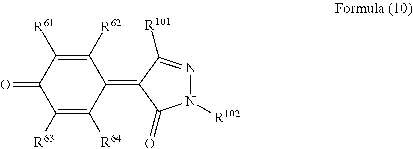

wherein in the formula (10), R¹⁰¹ and R¹⁰² each independently represent a hydrogen atom, a halogen atom, an alkyl group having 1 or more and 6 or less carbon atoms, or an aryl group having 6 or more and 12 or less carbon atoms.

Examples of the alkyl group having 1 or more and 6 or less carbon atoms in R⁷¹ to R¹⁰² include a linear alkyl group, a branched alkyl group, and a cyclic alkyl group. The number of carbon atoms of these alkyl groups is generally 1 or more and is generally 6 or less. Specific examples thereof include a methyl group, an ethyl group, a hexyl group, an isopropyl group, a tert-butyl group, a tert-amyl group, a cyclohexyl group. Among these, a methyl group, a tert-butyl group, and a tert-amyl group are preferred from the standpoint of the electron transporting capability.

Examples of the halogen atom include fluorine, chlorine, bromine, and iodine, and chlorine is preferred from the standpoint of the electron transporting capability.

The number of carbon atoms of the aryl group having 6 or more and 12 or less carbon atoms is generally 6 or more and is generally 12 or less. Specific examples thereof include a phenyl group and a naphthyl group, and a phenyl group is preferred from the standpoint of the film properties of the photosensitive layer. The aryl group may be further substituted.

The formula (6) is preferably the formula (7) or the formula (8), and more preferably the formula (7), among the formulae (7) to (10), from the standpoint of the image stability in repeated image formation. The compound represented by the formula (6) may be used alone, compounds represented by the formula (6) having different structures may be used in combination, and another electron transporting substance may also be used in combination.

The electron transporting substance having a larger molecular weight tends to exhibit good electric characteristics due to the higher effect of delocalizing the received electron thereof. The electron transporting substance having a larger molecular weight is also advantageous from the standpoint of the adhesiveness to the over coat layer due to the low migration thereof to the surface. From this standpoint, the molecular weight of the electron transporting substance is preferably 300 or more, more preferably 350 or more, further preferably 400 or more, and particularly preferably 420 or more. From the standpoint of the solubility, the molecular weight thereof is preferably 1,000 or less, and more preferably 700 or less.

One kind of the electron transporting substance may be used alone, or two or more kinds thereof may be used as an optional combination at an optional ratio. In the case where two or more kinds of the electron transporting substances are used in combination, the electron transporting substances having a molecular weight of 400 or more are preferably used from the standpoint of the electric characteristics and the migration to the surface described above. It is further preferred that among the two or more kinds of the electron transporting substances contained in the photosensitive layer, the molecular weight of the electron transporting substance having the maximum content (part by mass) in the photosensitive layer is 400 or more.

Preferred examples of the electron transporting substance are shown below.

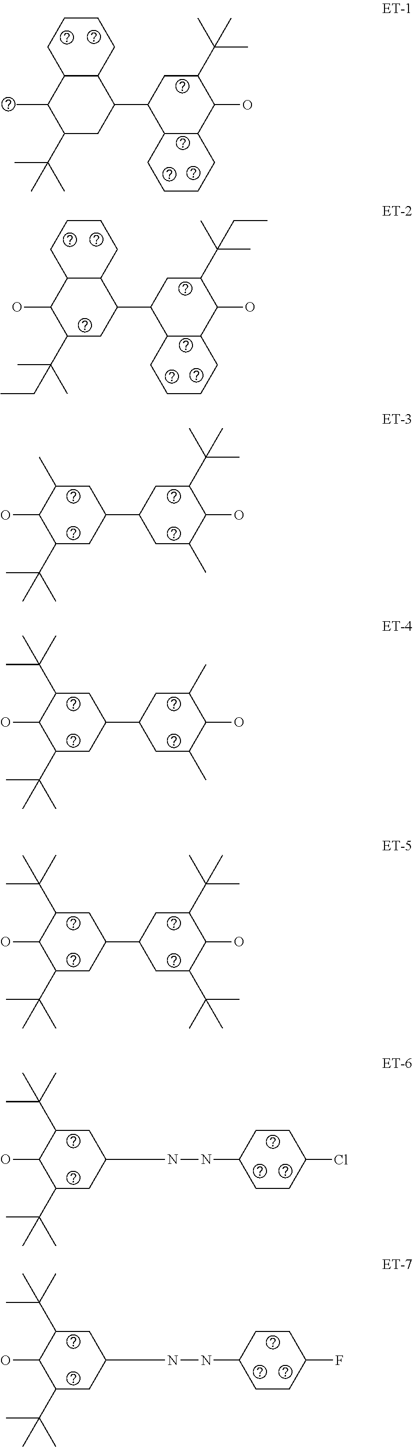

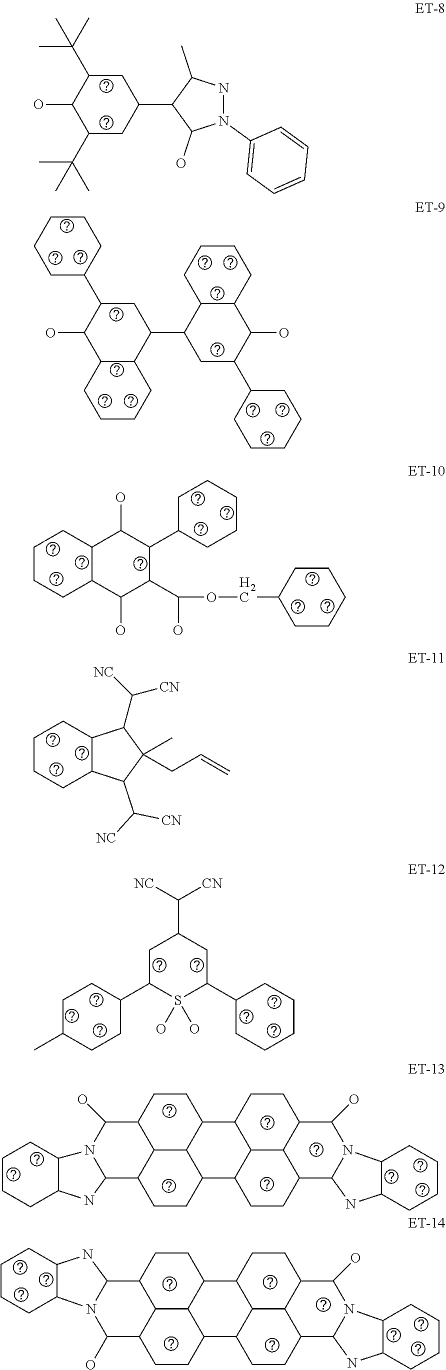

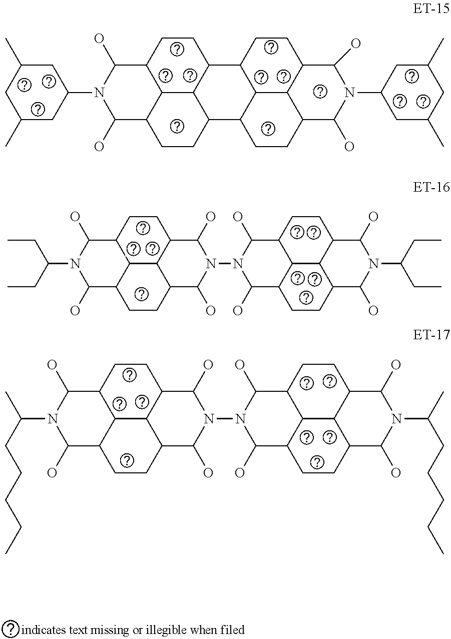

Among the electron transporting substances above, ET-1, ET-2, ET-3, ET-4, ET-5, ET-6, ET-8, ET-10, ET-11, ET-12, ET15, ET-16, and ET-17 are preferred, ET-1, ET-2, ET-3, ET-4, and ET-5 are more preferred, and ET-2 is further preferred, from the standpoint of the electric characteristics.

[Contents of Hole Transporting Substance and Electron Transporting Substance] In the present invention, the single layer type photosensitive layer preferably satisfies the expression (1) or the expression (2), and in the case where both the expressions are simultaneously satisfied, a photoreceptor having good electric characteristics can be provided.

Assuming that the content of the binder resin contained in the single layer type photosensitive layer in the present invention is 100, the content A (part by mass) of the hole transporting substance, the content B (part by mass) of the electron transporting substance, the molecular weight a of the hole transporting substance, and the molecular weight b of the electron transporting substance preferably satisfy the following expression (1) and the following expression (2).

0.9≤(B/b)/(A/a)≤4.0 (1)

0.15≤(A/a)+(B/b) (2)

(A/a) or (B/b) is a value obtained by dividing the content of the hole transporting substance or the electron transporting substance by the molecular weight thereof, and thus means the substance amount, i.e., the number of molecules.

In the positive charge system, holes and electrons generated through the charge separation in the single layer type photosensitive layer are necessarily transported in a well-balanced manner to the side of the conductive support for the holes and to the side of the photoreceptor surface for the electrons. It is considered that the transporting capabilities of holes and electrons are increased in proportion to the numbers of molecules of the hole transporting substance and the electron transporting substance in the photosensitive layer.

Accordingly, from the standpoint of the electric characteristics, there is a preferred range of the total amount of the hole transporting substance and the electron transporting substance required for performing sufficient charge transportation, and also there is a preferred range of the amount ratio between the hole transporting substance and the electron transporting substance.

In the present invention, (B/b)/(A/a) showing the ratio of the substance amount of the hole transporting substance and the substance amount of the electron transporting substance may be in the range of the expression (1), and thereby holes and electrons generated in the single layer type photosensitive layer can be transported in a well-balanced manner.

The case where (B/b)/(A/a) is 0.9 or less makes a state where the number of molecules of the electron transporting substance is small with respect to the hole transporting substance. In this state, the holes can be sufficiently transported to the side of the conductive support, whereas the transportation of the electrons to the side of the photoreceptor surface is delayed due to the small number of the molecules transporting the electrons. In the case where printing is repeated in this state, the number of electrons trapped in the photosensitive layer or the number of electrons remaining in the photosensitive layer due to the too low mobility thereof is increased to form a negative space charge, which weakens the electric field intensity in the photosensitive layer. Consequently, the transportation of the holes may also be delayed.

On the other hand, the case where (B/b)/(A/a) is 4.0 or more makes a state where the number of molecules of the hole transporting substance is small with respect to the electron transporting substance. In this state, the electron can be sufficiently transported to the side of the photoreceptor surface, whereas the transportation of the holes to the side of the conductive support is delayed due to the small number of the molecules transporting the holes. In the case where printing is repeated in this state, the number of holes trapped in the photosensitive layer or the number of holes remaining in the photosensitive layer due to the too low mobility thereof is increased to form a positive space charge, which weakens the electric field intensity in the photosensitive layer. Consequently, the transportation of the electrons may also be delayed.

Accordingly, there is a tendency that in the case where (B/b)/(A/a) is 0.9 or more, the electron transportability in the photosensitive layer can be secured, and in the case where (B/b)/(A/a) is 4.0 or less, the hole transportability in the photosensitive layer can be secured.

The value of (B/b)/(A/a) is generally 0.9 or more, preferably 1.1 or more, more preferably 1.3 or more, and further preferably 1.5 or more, from the standpoint of the aforementioned technical concept. The value of (B/b)/(A/a) is generally 4.0 or less, preferably 3.0 or less, more preferably 2.5 or less, and further preferably 2.2 or less, from the standpoint of the aforementioned technical concept. In the case where multiple kinds of the hole transporting substances are contained in the single layer type photosensitive layer, the value obtained by summating the values obtained by dividing the contents of the substances by the molecular weights thereof respectively is designated as (A/a). Similarly, in the case where multiple kinds of the electron transporting agents are contained in the single layer type photosensitive layer, the value obtained by summating the values obtained by dividing the contents of the substances by the molecular weights thereof respectively is designated as (B/b).

In the present invention, (A/a)+(B/b) showing the sum of the substance amount of the hole transporting substance and the substance amount of the electron transporting substance may be in the range of the expression (2), and thereby the absolute amount of the charge transporting substance required for performing charge transportation in the photosensitive layer can be secured.

The value of (A/a)+(B/b) is generally 0.15 or more, preferably 0.17 or more, and more preferably 0.20 or more, from the standpoint of the electric characteristics.

### Binder Resin

The binder resin used in the photosensitive layer will be described. Examples of the binder resin used in the photosensitive layer include a vinyl polymer, such as polymethyl methacrylate, polystyrene, and polyvinyl chloride or a copolymer thereof; a butadiene resin; a styrene resin; a vinyl acetate resin; a vinyl chloride resin; an acrylate ester resin; a methacrylate ester resin; a vinyl alcohol resin; a polymer and a copolymer of a vinyl compound, such as ethyl vinyl ether; a polyvinyl butyral resin; a polyvinyl formal resin; a partially modified polyvinyl acetal resin; a polyarylate resin; a polyamide resin; a polyurethane resin; a cellulose ester resin; a silicone-alkyd resin; a poly-N-vinylcarbazole resin; a polycarbonate resin; a polyester resin; a polyester carbonate resin; a polysulfone resin; a polyimide resin; a phenoxy resin; an epoxy resin; a silicone resin; and partially crosslinked cured products thereof. The resin may be modified with a silicon reagent or the like. One kind thereof may be used alone, or two or more kinds thereof may be used as an optional combination at an optional ratio.

The binder resin particularly preferably contains one kind or two or more kinds of a polymer obtained through interfacial polymerization.

The binder resin obtained through interfacial polymerization is preferably a polycarbonate resin or a polyester resin, and particularly preferably a polycarbonate resin or a polyarylate resin. A polymer obtained from an aromatic diol as a raw material is particularly preferred, and preferred examples of the aromatic diol compound include a compound represented by the following formula (11).

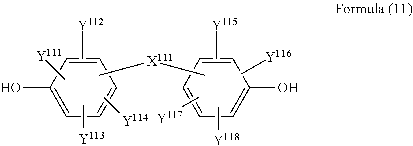

In the formula (11), X¹¹¹ represents a linking group represented by any one of the following formulae or a single bond.

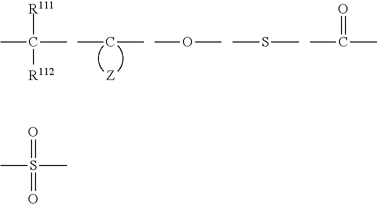

In the above formulae, R¹¹¹ and R¹¹² each independently represent a hydrogen atom, an alkyl group having 1 to 20 carbon atoms, an aryl group, which may be substituted, or a halogenated alkyl group; and Z represents a substituted or unsubstituted carbocyclic ring having 4 to 20 carbon atoms.

In the formula (11), Y¹¹¹ to Y¹¹⁸ each independently represent a hydrogen atom, a halogen atom, an alkyl group having 1 to 20 carbon atoms, an aryl group, which may be substituted, or a halogenated alkyl group.

A bisphenol having the following structural formulae, and a polycarbonate resin and a polyarylate resin containing the bisphenol component are preferred from the standpoint of the sensitivity and the residual potential of the electrophotographic photoreceptor, and among these, a polycarbonate resin is more preferred from the standpoint of the mobility.

These examples are shown for clarifying the substance of the present invention, and the structure is not limited to the examples unless the structure deviate from the substance of the present invention.

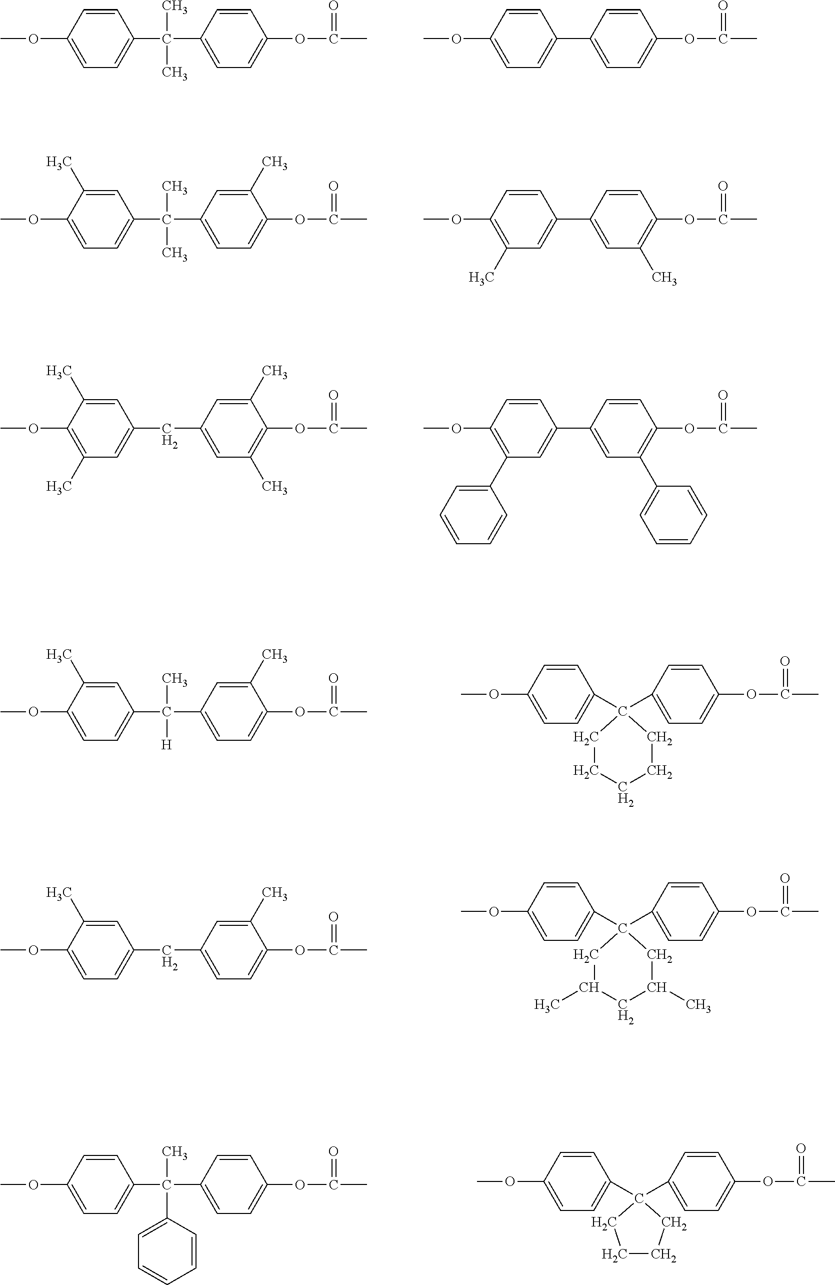

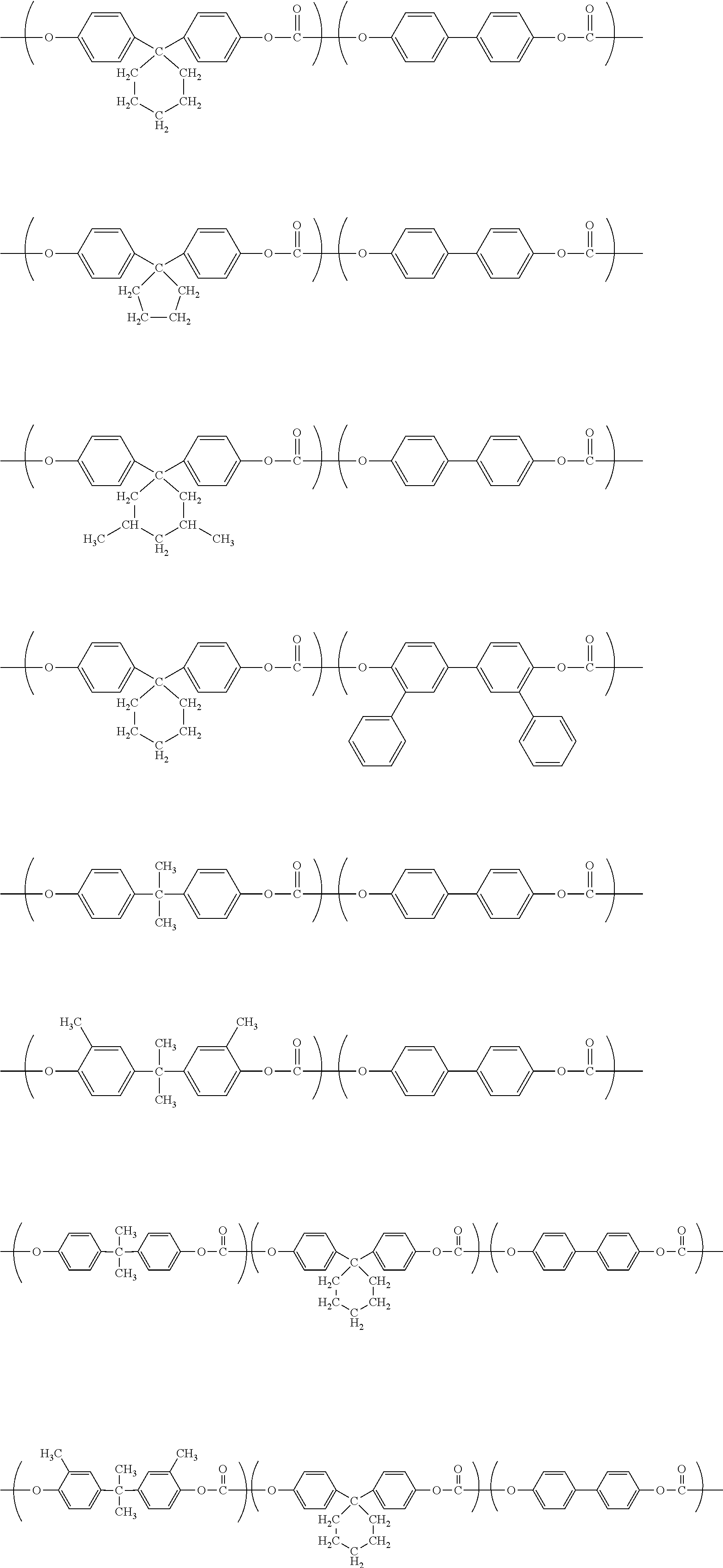

For exerting the effects of the present invention maximally, a polycarbonate containing a bisphenol derivative having the following structures is preferred.

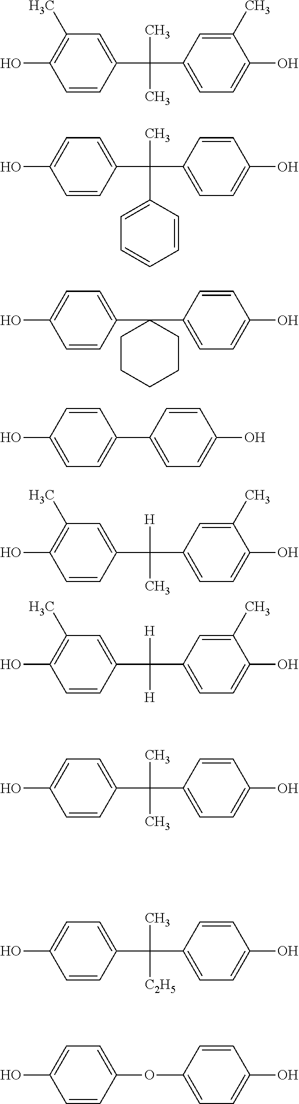

For enhancing the mechanical characteristics, a polyester, particularly a polyarylate, is preferably used, and in this case, a compound having the following structures as the bisphenol component is preferably used.

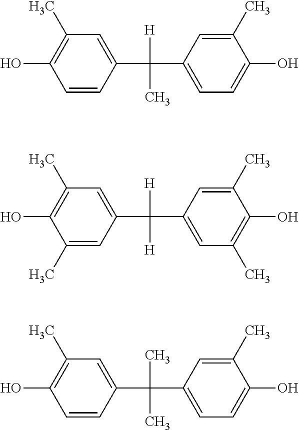 [SMILES: Cc1cc(C(C)c2ccc(O)c(C)c2)ccc1O ; Cc1cc(Cc2cc(C)c(O)c(C)c2)cc(C)c1O ; Cc1cc(C(C)(C)c2ccc(O)c(C)c2)ccc1O]

As the acid component, a compound having the following structures is preferably used.

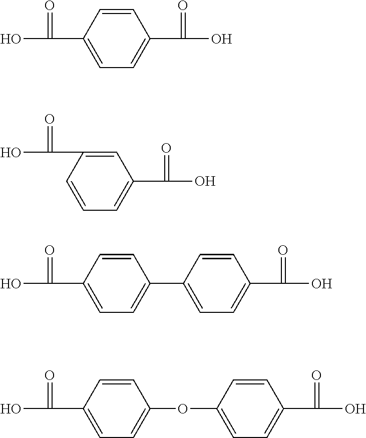 [SMILES: O=C(O)c1ccc(C(=O)O)cc1 ; O=C(O)c1cccc(C(=O)O)c1 ; O=C(O)c1ccc(-c2ccc(C(=O)O)cc2)cc1 ; O=C(O)c1ccc(Oc2ccc(C(=O)O)cc2)cc1]

In the case where terephthalic acid and isophthalic acid are used, the molar ratio of terephthalic acid is preferably larger, and a compound having the following structure is preferably used.

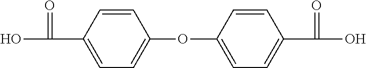 [SMILES: O=C(O)c1ccc(Oc2ccc(C(=O)O)cc2)cc1]

### Additional Substances

In addition to the aforementioned materials, the photosensitive layer may contain known additives, such as an antioxidant, a plasticizer, an ultraviolet ray absorbent, an electron withdrawing compound, a leveling agent, and a visible light shielding agent, for enhancing the film formability, the flexibility, the coatability, the contamination resistance, the gas resistance, the light resistance, and the like. The photosensitive layer may contain various additives, such as a sensitizer, a dye, a pigment (except for the charge generating substance, the hole transporting substance, and the electron transporting substance described above), and a surfactant, depending on necessity. Examples of the surfactant include a silicone oil and a fluorine based compound. In the present invention, one kind thereof or two or more kinds thereof may be appropriately used as an optional combination at an optional ratio.

The photosensitive layer may contain a fluorine based resin, a silicone resin, and the like for reducing the frictional resistance on the surface of the photosensitive layer, and particles formed of the resin and particles of an inorganic compound, such as aluminum oxide, may be contained therein.

### Antioxidant

The antioxidant is one kind of a stabilizer used for preventing oxidation of the electrophotographic photoreceptor of the present invention.

The antioxidant may be any compound that has a function of a radical scavenger, and specific examples thereof include a phenol derivative, an amine compound, a phosphonate ester, a sulfur compound, a vitamin, and a vitamin derivative.

Among these, a phenol compound, an amine compound, a vitamin, and the like are preferred. A hindered phenol having a bulky substituent near the hydroxy group, a trialkylamine derivative, and the like are more preferred.

An aryl compound derivative having a t-butyl group at the o-position of the hydroxy group and an aryl compound derivative having two t-butyl groups at the o-positions of the hydroxy group are particularly preferred.

With a too large molecular weight of the antioxidant molecule, there are cases where the antioxidation capability is decreased, and therefore a compound having a molecular weight of 1,500 or less, particularly a molecular weight of 1,000 or less, is preferred. The lower limit thereof is generally 100 or more, preferably 150 or more, and more preferably 200 or more.

The amount of the antioxidant used is not particularly limited, and may be 0.1 part by mass or more, and preferably 1 part by mass or more, per 100 parts by mass of the binder resin in the photosensitive layer. The amount thereof is preferably 25 parts by mass or less, and more preferably 20 parts by mass or less, for providing good electric characteristics and good printing resistance.

### Electron Withdrawing Compound

The photosensitive layer may contain an electron withdrawing compound. Specific examples of the electron withdrawing compound include a sulfonate ester compound, a carboxylate ester compound, an organic cyano compound, a nitro compound, and an aromatic halogen derivative, in which a sulfonate ester compound and an organic cyano compound are preferred, and a sulfonate ester compound is particularly preferred. One kind of the electron withdrawing compound may be used alone, or two or more kinds thereof may be used as an optional combination at an optional ratio.

It may be understood that the electron withdrawing capability of the electron withdrawing compound can be expected from the LUMO value (which may be hereinafter appropriately referred to as LUMOcal). In the present invention, among the above, a compound having a value of LUMOcal, which is obtained through the structure optimization using semi-empirical molecular orbital calculation with the PM3 parameter (which may be hereinafter referred simply to as through the semi-empirical molecular orbital calculation), of 0.5 eV or more and 5.0 eV or less is preferably used. A better effect of the electron withdrawing capability is expected with an absolute value of LUMOcal of 0.5 eV or more, and better charge can be obtained with the absolute value thereof of 5.0 eV or less. The absolute value of LUMOcal is more preferably 1.0 eV or more, more preferably 1.1 eV or more, and particularly preferably 1.2 eV or more. The absolute value is preferably 4.5 eV or less, more preferably 4.0 eV or less, and particularly preferably 3.5 eV or less.

Examples of the compound having an absolute value of LUMOcal in the aforementioned range include the following compounds.

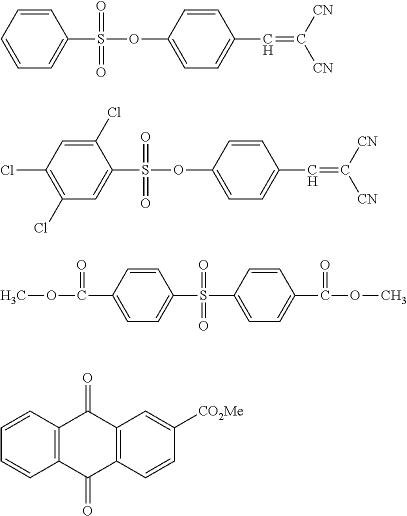

The amount of the electron withdrawing compound used in the electrophotographic photoreceptor in the present invention is not particularly limited, and in the case where the electron withdrawing compound is used in the photosensitive layer, the amount thereof is preferably 0.01 part by mass or more, and more preferably 0.05 part by mass or more, per 100 parts by mass of the binder resin contained in the photosensitive layer. The amount thereof is generally preferably 50 parts by mass or less, more preferably 40 parts by mass or less, and further preferably 30 parts by mass or less, for providing good electric characteristics.

### Formation Method of Single Layer Type Photosensitive Layer

The formation method of the single layer type photosensitive layer will be described. The formation method of the single layer type photosensitive layer is not particularly limited, and may be performed, for example, by dispersing the charge generating substance in a coating liquid having the charge transporting substance, the binder resin, and the other substances dissolved (or dispersed) in a solvent (or a dispersion medium), and coating the coating liquid on the conductive support (or in the case where an intermediate layer, such as an undercoating layer, is provided, on the intermediate layer).

The solvent or the dispersion medium, and the coating method used for forming the single layer type photosensitive layer will be described.

[Solvent or Dispersion Medium] Examples of the solvent or the dispersion medium used for forming the photosensitive layer include an alcohol compound, such as methanol, ethanol, propanol, and 2-methoxyethanol; an ether compound, such as tetrahydrofuran, 1,4-dioxane, and dimethoxyethane; an ester compound, such as methyl formate and ethyl acetate; a ketone compound, such as acetone, methyl ethyl ketone, and cyclohexanone; an aromatic hydrocarbon compound, such as benzene, toluene, xylene, and anisole; a chlorinated hydrocarbon compound, such as dichloromethane, chloroform, 1,2-dichloroethane, 1,1,2-trichloroethane, 1,1,1-trichloroethane, tetrachloroethane, 1,2-dichloropropane, and trichloroethylene; a nitrogen-containing compound, such as n-butylamine, isopropanolamine, diethylamine, triethanolamine, ethylenediamine, and triethylenediamine; and an aprotic polar solvent, such as acetonitrile, N-methylpyrrolidone, N,N-dimethylformamide, and dimethylsulfoxide. One kind thereof may be used alone, or two or more kinds thereof may be used as an optional combination at an optional ratio.

[Coating Method] Examples of the coating method of the coating liquid for forming the single layer type photosensitive layer include a spray coating method, a spiral coating method, a ring coating method, and a dip coating method.

Examples of the spray coating method include air spray, airless spray, static air spray, static airless spray, rotational atomization type static spray, hot spray, and hot airless spray. In consideration of fine atomization, adhesion efficiency, and the like for providing a uniform film thickness, the rotational atomization type static spray with the conveying method described in JP H1-805198 A1, i.e., cylindrical works are rotated and continuously conveyed in the axial direction thereof with no gap, is preferred. According to the procedure, a photosensitive layer excellent in uniformity of the film thickness can be obtained with high overall adhesion efficiency.

Examples of the spiral coating method include a method using an injection coating machine or a curtain coating machine described in JPS52-119651 A, a method of continuously flying a paint in a stripe form from a minute aperture described in JPH1-231966 A, and a method using a multi-nozzle unit described in JPH3-193161 A.

In the dipping method, the total solid concentration of the coating liquid or the dispersion liquid is preferably 5% by mass or more, and more preferably 10% by mass or more, and is preferably 50% by mass or less, and more preferably 35% by mass or less.

The viscosity of the coating liquid or the dispersion liquid is preferably 50 mPa·s or more, and more preferably 100 mPa·s or more, and is preferably 700 mPa·s or less, and more preferably 500 mPa·s or less. According to the configuration, a photosensitive layer excellent in uniformity of the film thickness can be provided.

After forming a coated film in the coating method above, the coated film is dried, and during the drying, the drying temperature and time are preferably regulated to perform necessary and sufficient drying. The drying temperature is generally 80° C. or more, and preferably 100° C. or more, from the standpoint of suppressing the residual solvent. The drying temperature is generally 250° C. or less, preferably 170° C. or less, and more preferably 140° C. or less, and the temperature may be changed in a stepwise manner, from the standpoint of the prevention of occurrence of bubbles and the electric characteristics. Examples of the drying method used include a hot air dryer, a steam dryer, an infrared dryer, and far infrared dryer.

In the present invention, the over coat layer is provided, and therefore the photosensitive layer may be only air dried at room temperature after coating, and after coating the over coat layer, drying under heating may be performed in the aforementioned method.

Regarding the thickness of the photosensitive layer, an appropriate thickness is selected depending on the material used and the like, and the thickness is preferably 5 μm or more, more preferably 10 μm or more, and particularly preferably 15 μm or more, from the standpoint of the electric characteristics, the insulation breakdown resistance, and the like. The thickness thereof is preferably 100 μm or less, more preferably 50 μm or less, and particularly preferably 30 μm or less, from the standpoint of the electric characteristics.

### Over Coat Layer

The over coat layer of the photoreceptor of the present invention has a feature having a structure formed through polymerization of a compound having a chain polymerizable functional group.

The compound having a chain polymerizable functional group generally has 2 or more, preferably 3 or more, and more preferably 4 or more, and on the other hand, generally 15 or less, preferably 10 or less, and more preferably 8 or less chain polymerizable functional groups from the standpoint of the abrasion resistance.

Examples of the chain polymerizable functional group of the compound having a chain polymerizable functional group include an acryloyl group, a methacryloyl group, a vinyl group, and an epoxy group. Any known compound having a chain polymerizable functional group may be used with no particular limitation, and a monomer, an oligomer, and a polymer having an acryloyl group or a methacryloyl group are preferred from the standpoint of the curability.

Examples of the preferred compound will be described. Examples of the monomer having an acryloyl group or a methacryloyl group include trimethylolpropane triacrylate (A-TMPT), trimethylolpropane trimethacrylate, HPA-modified trimethylolpropane triacrylate, EO-modified trimethylolpropane triacrylate, PO-modified trimethylolpropane triacrylate, caprolactone-modified trimethylolpropane triacrylate, HPA-modified trimethylolpropane trimethacrylate, pentaerythritol triacrylate, pentaerythritol tetraacrylate, glycerol triacrylate, ECH-modified glycerol triacrylate, EO-modified glycerol triacrylate, PO-modified glycerol triacrylate, tris(acryloxyethyl) isocyanurate, caprolactone-modified tris(acryloxyethyl) isocyanurate, EO-modified tris(acryloxyethyl) isocyanurate, PO-modified tris(acryloxyethyl) isocyanurate, dipentaerythritol hexaacrylate (A-DPH), caprolactone-modified dipentaerythritol hexaacrylate, dipentaerythritol hydroxypentaacrylate, alkyl-modified dipentaerythritol pentaacrylate, alkyl-modified dipentaerythritol tetraacrylate, alkyl-modified dipentaerythritol triacrylate, dimethylolpropane tetraacrylate, pentaerythritol ethoxytetraacrylate, EO-modified phosphate triacrylate, 2,2,5,5-tetrahydroxymethylcyclopentanone tetraacrylate, 2-hydroxy-3-acryloyloxypropyl methacrylate, polyethylene glycol diacrylate, polypropylene glycol diacrylate, polytetramethylene glycol diacrylate, EO-modified bisphenol A diacrylate, PO-modified bisphenol A diacrylate, 9,9-bis[4-(2-acryloyloxyethoxy)phenyl]fluorene, tricyclodecanedimethanol diacrylate, decanediol diacrylate, hexanediol diacrylate, ethylene glycol dimethacrylate, polyethylene glycol dimethacrylate, EO-modified bisphenol A dimethacrylate, PO-modified bisphenol A dimethacrylate, tricyclodecanedimethanol dimethacrylate, decanediol dimethacrylate, and hexanediol dimethacrylate.

Examples of the oligomer and the polymer having an acryloyl group or a methacryloyl group include a urethane acrylate, an ester acrylate, an acrylic acrylate, and an epoxy acrylate, known in the art. Examples of the urethane acrylate include “EBECRYL8301”, “EBECRYL1290”, “EBECRYL1830”, and “KRM8200” (available from Daicel-Allnex, Ltd.), and “UV1700B”, “UV7640B”, “UV7605B”, “UV6300B”, and “UV7550B” (available from Mitsubishi Chemical Corporation). Examples of the ester acrylate include “M-7100”, “M-7300K”, “M-8030”, “M-8060”, “M-8100”, “M-8530”, “M-8560”, and “M-9050” (available from Toagosei Co., Ltd.). Examples of the acrylic acrylate include “8BR-600”, “8BR-930MB”, “8KX-078”, “8KX-089”, and “8KX-168” (available from Taisei Fine Chemical Co., Ltd.).

These compounds may be used alone or as a combination of two or more kinds thereof. Among these, a urethane acrylate is preferably contained from the standpoint of the electric characteristics.

The over coat layer of the electrophotographic photoreceptor according to the present invention may contain metal oxide particles and a charge transporting substance for the purpose of imparting a charge transporting capability, in addition to the compound having a chain polymerizable functional group. The over coat layer may also contain a polymerization initiator for accelerating the polymerization reaction.

The materials used in the over coat layer (i.e., the metal oxide particles, the charge transporting substance, and the polymerization initiator) will be described in detail below.

### Metal Oxide Particles

The over coat layer of the present invention preferably contains metal oxide particles from the standpoint of imparting a charge transporting capability and the standpoint of enhancing the mechanical strength.

The metal oxide particles used may be any type of metal oxide particles that are generally applicable to electrophotographic photoreceptors. More specific examples of the metal oxide particles include metal oxide particles containing one kind of a metal element, such as titanium oxide, tin oxide, aluminum oxide, indium oxide, silicon oxide, zirconium oxide, zinc oxide, and iron oxide, and metal oxide particles containing multiple kinds of metal elements, such as indium tin oxide, calcium titanate, strontium titanate, and barium titanate. Among these, metal oxide particles that have a band gap of 2 to 4 eV are preferred. One kind of the metal oxide particles may be used alone, or multiple kinds of particles may be used by mixing. Among the metal oxide particles, titanium oxide, tin oxide, indium tin oxide, aluminum oxide, silicon oxide, and zinc oxide are preferred, titanium oxide and tin oxide are more preferred, and titanium oxide is particularly preferred, from the standpoint of the electron transporting capability.

The crystal form of titanium oxide particles may be any of rutile, anatase, brookite, and amorphous. Multiple kinds of crystal states from these crystal states may be contained.

The metal oxide particles may have a surface having been subjected to various surface treatments. For example, the surface thereof may be subjected to a treatment with an inorganic material, such as tin oxide, aluminum oxide, antimony oxide, zirconium oxide, and silicon oxide, or an organic material, such as stearic acid, a polyol, and an organic silicon compound. In the case where titanium oxide particles are used, in particular, the surface thereof is preferably treated with an organic silicon compound. Examples of the organic silicon compound include a silicone oil, such as dimethylpolysiloxane and methyl hydrogen polysiloxane, an organosilane, such as methyldimethoxysilane and diphenyldimethoxysilane, a silazane, such as hexamethyldisilazane, and a silane coupling agent, such as 3-methacryloyloxypropyltrimethoxysilane, 3-acryloyloxypropyltrimethoxysilane, vinyltrimethoxysilane, Υ-mercaptopropyltrimethoxysilane, and Υ-aminopropyltriethoxysilane. In particular, 3-methacryloyloxypropyltrimethoxysilane, 3-acryloyloxypropyltrimethoxysilane, vinyltrimethoxysilane, which have a chain polymerizable functional group, are preferred from the standpoint of enhancing the mechanical strength of the over coat layer.

The outermost surface of the surface-treated particles has been treated with the aforementioned treating agent, and before the treatment, may be treated with a treating agent, such as aluminum oxide, silicon oxide, and zirconium oxide. One kind of the metal oxide particles may be used alone, or multiple kinds of the particles may be used by mixing.

The metal oxide particles used generally have an average primary particle diameter of preferably 500 nm or less, more preferably 1 to 100 nm, and further preferably 5 to 50 nm. The average primary particle diameter can be obtained from the arithmetic average value of the diameters of the particles that are directly observed with a transmission electron microscope (which may be hereinafter referred to as TEM).

As the metal oxide particles in the present invention, specific examples of the trade name of titanium oxide particles include titanium oxide ultrafine particles subjected to no surface treatment “TTO-55(N)” and “TTO-51(N)”, titanium oxide ultrafine particles coated with Al₂O₃ “TTO-55(A)” and “TTO-55(B)”, titanium oxide ultrafine particles subjected to surface treatment with stearic acid “TTO-55(C)”, titanium oxide ultrafine particles subjected to surface treatment with Al₂O₃ and organosiloxane “TTO55(S)”, high purity titanium oxide “C-EL”, sulfuric acid method titanium oxide “R-550”, “R-580”, “R-630”, “R-670”, “R-680”, “R-780”, “A-100”, “A-220”, and “W-10”, chlorine method titanium oxide “CR-50”, “CR-58”, “CR-60”, “CR-60-2”, and “CR-67”, and conductive titanium oxide “ET-300W” (all available from Ishihara Sangyo Kaisha, Ltd.), titanium oxide “R-60”, “A-110”, and “A-150”, Al₂O₃-coated titanium oxide “SR-1”, “RGL”, “R-5N”, “R-5N-2”, “R-52N”, “RK-1”, and “A-SP”, SiO₂ and Al₂O₃-coated titanium oxide “R-GX” and “R-7E”, ZnO, SiO₂, and Al₂O₃-coated titanium oxide “R-650”, and ZrO₂ and Al₂O₃-coated titanium oxide “R-61N” (all available from Sakai Chemical Industry Co., Ltd.), titanium oxide subjected to surface treatment with SiO₂ and Al₂O₃ “TR-700”, titanium oxide subjected to surface treatment with ZnO, SiO₂, and Al₂O₃ “TR-840” and “TA-500”, titanium oxide subjected to no surface treatment “TA-100”, “TA-200”, and “TA-300”, and titanium oxide subjected to surface treatment with Al₂O₃ “TA-400” (all available from Fuji Titanium Industry Co., Ltd.), and titanium oxide subjected to no surface treatment “MT-150W” and “MT-500B”, titanium oxide subjected to surface treatment with SiO₂ and Al₂O₃ “MT-100SA” and “MT-500SA”, and titanium oxide subjected to surface treatment with SiO₂, Al₂O₃, and organosiloxane “MT-100SAS” and “MT-500SAS” (all available from Tayca Co., Ltd.).

Specific examples of the trade name of aluminum oxide particles include “Aluminium Oxide C” (available from Nippon Aerosil Co., Ltd.).

Specific examples of the trade name of silicon oxide particles include “200CF” and “R972” (all available from Nippon Aerosil Co., Ltd.), and “KEP-30” (available from Nippon Shokubai Co., Ltd.).

Specific examples of the trade name of tin oxide particles include “SN-100P” and “SN-100D” (all available from Ishihara Sangyo Kaisha, Ltd.), “SnO₂” (available from CIK NanoTek Corporation), and “S-2000”, phosphorus-doped tin oxide “SP-2”, antimony-doped tin oxide “T-1”, and indium-doped tin oxide “E-ITO” (all available from Mitsubishi Materials Corporation).

Specific examples of the trade name of zinc oxide particles include “MZ-305S” (available from Tayca Co., Ltd.). The metal oxide particles capable of being used in the present invention are not limited to these materials.

The content of the metal oxide particles in the over coat layer of the electrophotographic photoreceptor according to the present invention is not particularly limited, is preferably 10 parts by mass or more, more preferably 20 parts by mass or more, and particularly preferably 30 parts by mass or more, from the standpoint of the electric characteristics, and is preferably 300 parts by mass or less, more preferably 200 parts by mass or less, and particularly preferably 120 parts by mass or less, from the standpoint of retaining a good surface resistance, all per 100 parts by mass of the binder resin.

### Charge-Transporting Substance

The charge transporting substance contained in the over coat layer may be the same as the charge transporting substance used in the photosensitive layer.

A structure formed through polymerization of a charge transporting substance having a chain polymerizable functional group may be contained from the standpoint of enhancing the Martens hardness of the photoreceptor surface. Examples of the chain polymerizable functional group of the charge transporting substance having a chain polymerizable functional group include an acryloyl group, a methacryloyl group, a vinyl group, and an epoxy group. Among these, an acryloyl group and a methacryloyl group are preferred from the standpoint of the curability. Examples of the structure of the charge transporting substance moiety of the charge transporting substance having a chain polymerizable functional group include an electron donating substance, for example, a heterocyclic compound, such as a carbazole derivative, an indole derivative, an imidazole derivative, an oxazole derivative, a pyrazole derivative, a thiadiazole derivative, and an benzofuran derivative, and an aniline derivative, a hydrazone derivative, an aromatic amine derivative, an arylamine derivative, a stilbene derivative, a butadiene derivative, and an enamine derivative, and a combination of multiple kinds of these compounds bonded to each other, and a polymer having a group formed of any of these compounds on the main chain or the side chain thereof. Among these, a carbazole derivative, an aromatic amine derivative, an arylamine derivative, a stilbene derivative, a butadiene derivative, and an enamine derivative, and a combination of multiple kinds of these compounds bonded to each other are preferred from the standpoint of the electric characteristics.

The partial structure having a charge transporting capability is preferably a structure represented by the following formula (4).

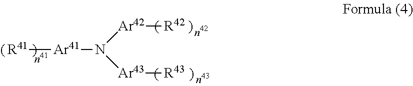

In the formula (4), Ar⁴¹ to Ar⁴³ each represent an aromatic group; R⁴¹ to R⁴³ each independently represent a hydrogen atom, an alkyl group, an alkoxy group, an aryl group, a halogenated alkyl group, a halogen group, a benzyl group, or the following formula (5); and n⁴¹ to n⁴³ each represent an integer of 1 or more, provided that in the case where n⁴¹ is 1, R⁴¹ is the formula (5); in the case where n⁴¹ is an integer of 2 or more, R⁴¹ may be the same as or different from each other, at least one of which is the formula (5); in the case where n⁴² is an integer of 2 or more, R⁴² may be the same as or different from each other; and in the case where n⁴³ is an integer of 2 or more, R⁴³ may be the same as or different from each other.

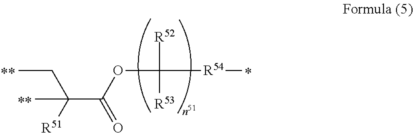

In the formula (5), R⁵¹ represents a hydrogen atom or a methyl group; R⁵² and R⁵³ each independently represent a hydrogen atom, a hydrocarbon group, or an alkoxy group; R⁵⁴ represents a single bond or an oxygen atom; n⁵¹ represents an integer of 0 or more and 10 or less; * represents a bonding site to Ar⁴¹ to Ar⁴³; and ** represents a bonding site to an arbitrary atom.

In the formula (4), Ar⁴¹ to Ar⁴³ each represent an aromatic group, and a monovalent aromatic group include a phenyl group, a naphthyl group, an anthracenyl group, a phenanthrenyl group, a pyrenyl group, a biphenylyl group, and a fluorenyl group. Among these, a phenyl group is preferred from the standpoint of the solubility and the photocurability. Examples of the divalent aromatic group include a phenylene group, a naphthylene group, an anthrylene group, a phenanthrenediyl group, a pyrenylene group, and a biphenyldiyl group. Among these, a phenylene group is preferred from the standpoint of the solubility and the photocurability.

R⁴¹ to R⁴³ each independently represent a hydrogen atom, an alkyl group, an alkoxy group, an aryl group, a halogenated alkyl group, a halogen group, a benzyl group, or the formula (5). Among these, the number of carbon atoms of the alkyl group, the alkoxy group, and the halogenated alkyl group is generally 1 or more and 10 or less, preferably 8 or less, more preferably 6 or less, and further preferably 4 or less. Specific examples of the alkyl group include a methyl group, an ethyl group, a propyl group, an isopropyl group, a butyl group, a tert-butyl group, an isobutyl group, and a cyclohexyl group. Specific examples of the alkoxy group include a methoxy group, an ethoxy group, a propoxy group, and a cyclohexyloxy group. Examples of the halogenated alkyl group include a chloroalkyl group and a fluoroalkyl group. Examples of the halogen group include a fluoro group, a chloro group, and a bromo group. A methyl group, an ethyl group, and a phenyl group are more preferred.

n⁴¹ to n⁴³ each represent an integer of 1 or more, generally 1 or more and 5 or less, preferably 3 or less, and most preferably 1, provided that in the case where n⁴¹ is 1, R⁴¹ is the formula (5); in the case where n⁴¹ is an integer of 2 or more, R⁴¹ may be the same as or different from each other, at least one of which is the formula (5); in the case where n⁴² is an integer of 2 or more, R⁴² may be the same as or different from each other; and in the case where n⁴³ is an integer of 2 or more, R⁴³ may be the same as or different from each other. The case where n⁴¹ to n⁴³ are 1, R⁴¹ is the formula (5), and any one of R⁴² and R⁴³ is the formula (5), and the case where n⁴¹ to n⁴³ are 1, R⁴¹ to R⁴³ are the formula (5) are preferred from the standpoint of the strength of the cured film, and the case where n⁴¹ to n⁴³ are 1, R⁴¹ is the formula (5), and any one of R⁴² and R⁴³ is the formula (5) is more preferred from the standpoint of the solubility.

Examples of R⁵² and R⁵³ include the equivalent ones to R²² and R²³.

n⁵¹ represents an integer of 0 or more and 10 or less, generally 0 or more and 10 or less, preferably 6 or less, more preferably 4 or less, and further preferably 3 or less.

The raw material of the polymer having a structure represented by the formula (4) is not particularly limited, and the polymer is preferably obtained through polymerization of a compound having a structure represented by the following formula (4′).

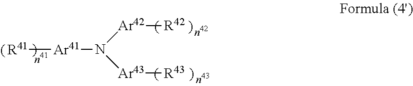

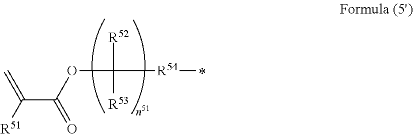

In the formula (5′), R⁵¹ represents a hydrogen atom or a methyl group; R⁵² and R⁵³ each independently represent a hydrogen atom, a hydrocarbon group, or an alkoxy group; R⁵⁴ represents a single bond or an oxygen atom; n⁵¹ represents an integer of 0 or more and 10 or less; and * represents a bonding site to Ar⁴¹ to Ar⁴³.

Examples of the compound having a structure represented by the formula (4′) are shown below.

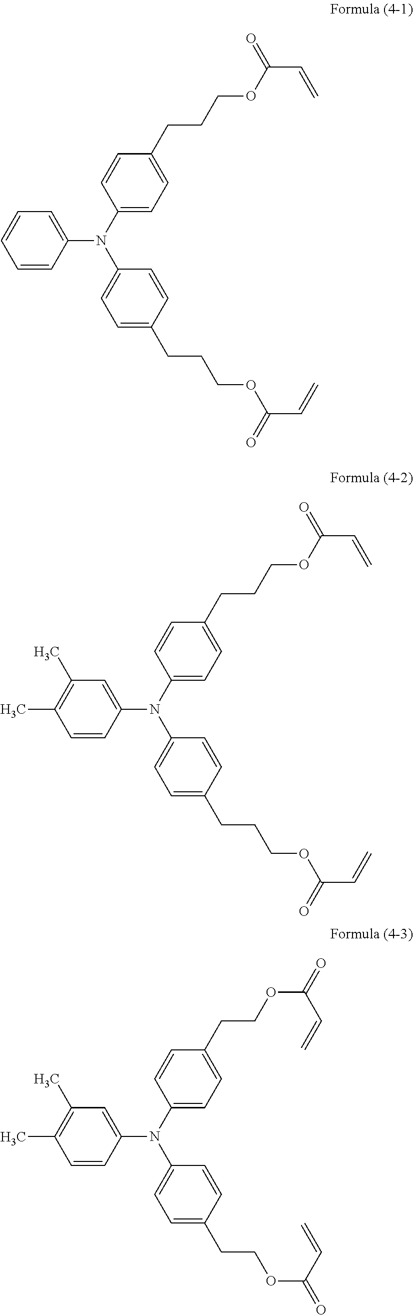

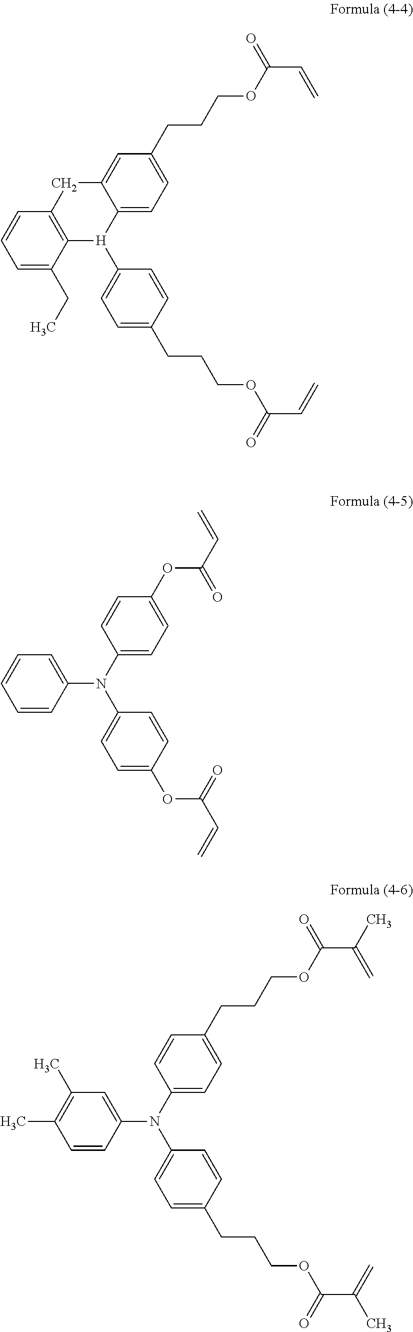

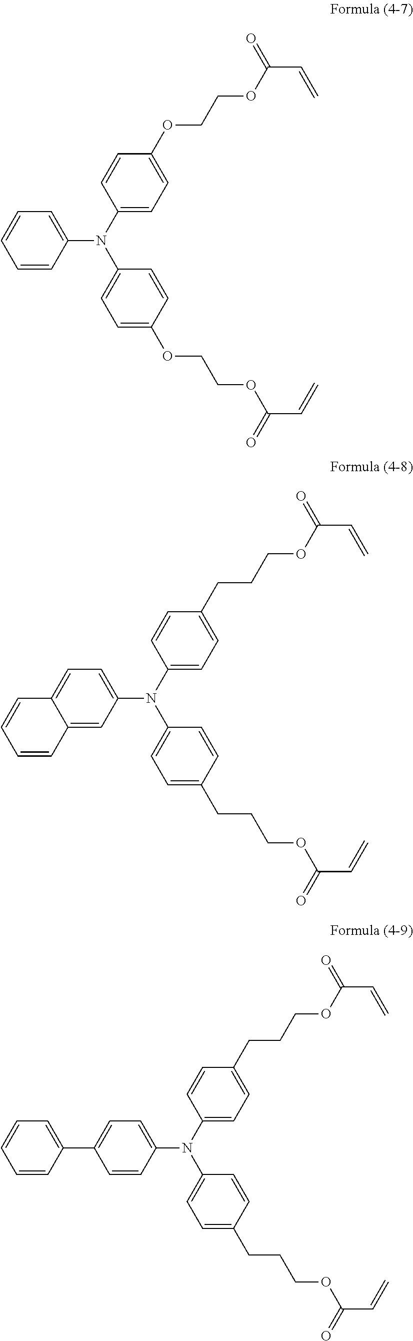 [SMILES: C=CC(=O)OCCOc1ccc(N(c2ccccc2)c2ccc(OCCOC(=O)C=C)cc2)cc1 ; C=CC(=O)OCCCc1ccc(N(c2ccc(CCCOC(=O)C=C)cc2)c2ccc3ccccc3c2)cc1 ; C=CC(=O)OCCCc1ccc(N(c2ccc(CCCOC(=O)C=C)cc2)c2ccc(-c3ccccc3)cc2)cc1]

Among the compounds, the formula (4-1), the formula (4-2), the formula (4-3), the formula (4-4), the formula (4-6), and the formula (4-7) are preferred, and the formula (4-1), the formula (4-2), and the formula (4-3) are more preferred.

The amount of the charge transporting substance used in the over coat layer of the electrophotographic photoreceptor according to the present invention is not particularly limited, is preferably 10 parts by mass or more, more preferably 30 parts by mass or more, and particularly preferably 50 parts by mass or more, from the standpoint of the electric characteristics, and is preferably 300 parts by mass or less, more preferably 200 parts by mass or less, and particularly preferably 150 parts by mass or less, from the standpoint of retaining a good surface resistance, all per 100 parts by mass of the binder resin.

### Polymerization Initiator

The polymerization initiator includes a thermal polymerization initiator and a photopolymerization initiator.

Examples of the thermal polymerization initiator include a peroxide based compound, such as 2,5-dimethylhexane-2,5-dihydroperoxide, dicumyl peroxide, benzoyl peroxide, t-butyl peroxide, t-butylcumyl peroxide, t-butyl hydroperoxide, cumene hydroperoxide, and lauroyl peroxide, and an azo based compound, such as 2,2′-azobis(isobutyronitrile), 2,2′-azobis(2-methylbutyronitrile), 2,2′-azobis(2,4-dimethylvaleronitrile), 2,2′-azobis(cyclohexanecarbonitrile), 2,2′-azobis(methyl isobutyrate), 2,2′-azobis(isobutylamidine hydrochloride), and 4,4′-azobis-4-cyano valeric acid.

The photopolymerization initiator is classified into a direct cleavage type and a hydrogen abstraction type depending on the difference in radical generation mechanism. The photopolymerization initiator of the direct cleavage type receives light energy, and a part of the covalent bonds in the molecule is cleaved to generate radicals. The photopolymerization initiator of the hydrogen abstraction type receives light energy, and the molecule becoming an excitation state thereby abstracts hydrogen from the hydrogen donor to generate radicals.

Examples of the photopolymerization initiator of the direct cleavage type include an acetophenone based or ketal based compound, such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone, a benzoin ether based compound, such as benzoin, benzoin methyl ether, benzoin ethyl ether, benzoin isobutyl ether, benzoin isopropyl ether, and O-tosylbenzoin, and an acylphosphine oxide based compound, such as diphenyl(2,4,6-trimethylbenzoyl)phosphine oxide, phenylbis(2,4,6-trimethylbenzoyl)phosphine oxide, and lithium phenyl(2,4,6-trimethylbenzoyl)phosphonate oxide.

Examples of the photopolymerization initiator of the hydrogen abstraction type include a benzophenone based compound, such as benzophenone, 4-benzoylbenzoic acid, 2-benzoylbenzoic acid, methyl 2-benzoylbenzoate, methyl benzoylformate, benzil, p-anisyl, 2-benzoylnaphthalene, 4,4′-bis(dimethylamino)benzophenone, 4,4′-dichlorobenzophenone, and 1,4-dibenzoylbenzene, and an anthraquinone based or thioxanthone based compound, such as 2-ethylanthraquinone, 2-isopropylthioxanthone, 2-chlorothioxanthone, 2,4-dimethylthioxanthone, 2,4-diethylthioxanthone, and 2,4-dichlorothioxanthone. Examples of other photopolymerization initiators include camphorquinone, 1-phenyl-1,2-propanedione-2-(o-ethoxycarbonyl)oxime, an acridine based compound, a triazine based compound, and an imidazole based compound.

The photopolymerization initiator preferably has an absorption wavelength in the wavelength region of the light source used for light irradiation, for generating radicals efficiently through absorption of light energy. In the case where a component other than the photopolymerization initiator among the compounds contained in the over coat layer has absorption in this wavelength region, there are cases where the photopolymerization initiator cannot absorb sufficient energy, which reduces the radical generation efficiency. The ordinary binder resin, charge transporting substance, and metal oxide particles have absorption wavelengths in the ultraviolet (UV) region, and therefore this effect becomes conspicuous particularly in the case where the light source used for light irradiation emits ultraviolet (UV) light. From the standpoint of preventing the failure, an acylphosphine oxide based compound, which has an absorption wavelength on a relatively long wavelength side among the photopolymerization initiators, is preferably contained. The acylphosphine oxide based compound is preferred since the compound has the photobleaching effect, in which the absorption wavelength region is shifted to the low wavelength side through self-cleavage, so as to allow light to permeate the interior of the over coat layer, resulting in good internal curability. In this case, a hydrogen abstraction type initiator is preferably used in combination from the standpoint of supplementing the curability of the over coat layer surface. The content ratio of the hydrogen abstraction type initiator with respect to the acylphosphine oxide based compound is not particularly limited, is preferably 0.1 part by mass or more from the standpoint of supplementing the surface curability, and is preferably 5 parts by mass or less from the standpoint of retaining the internal curability, all per 1 part by mass of the acylphosphine oxide based compound.

A compound having a photopolymerization acceleration effect may be used alone or as a combination with the aforementioned photopolymerization initiator. Examples thereof include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

One kind of the polymerization initiator may be used, or two or more kinds thereof may be used by mixing. The content of the polymerization initiator may be 0.5 to 40 parts by mass, and preferably 1 to 20 parts by mass, per 100 parts by mass of the total amount of the contents having radical polymerizability.

### Formation Method of Over Coat Layer

The formation method of the over coat layer will be described. The formation method of the over coat layer is not particularly limited, and for example, the over coat layer can be formed by coating a coating liquid having the compound having a chain polymerizable functional group, the charge transporting substance, the metal oxide particles, and the other substance dissolved in a solvent or dispersed in a dispersion medium.

The solvent or dispersion medium used for forming the over coat layer, and the coating method therefor will be described.

[Solvent used in Coating Liquid for forming Over coat layer] The organic solvent used in the coating liquid for forming the over coat layer of the present invention may be any organic solvent that can dissolve the substances relating to the present invention. Specific examples thereof include an alcohol compound, such as methanol, ethanol, propanol, and 2-methoxyethanol; an ether compound, such as tetrahydrofuran, 1,4-dioxane, and dimethoxyethane; an ester compound, such as methyl formate and ethyl acetate; a ketone compound, such as acetone, methyl ethyl ketone, and cyclohexanone; an aromatic hydrocarbon compound, such as benzene, toluene, xylene, and anisole; a chlorinated hydrocarbon compound, such as dichloromethane, chloroform, 1,2-dichloroethane, 1,1,2-trichloroethane, 1,1,1-trichloroethane, tetrachloroethane, 1,2-dichloropropane, and trichloroethylene; a nitrogen-containing compound, such as n-butylamine, isopropanolamine, diethylamine, triethanolamine, ethylenediamine, and triethylenediamine; and an aprotic polar solvent, such as acetonitrile, N-methylpyrrolidone, N, N-dimethylformamide, and dimethylsulfoxide. A mixed solvent among these may be used as an optional combination at an optional ratio. An organic solvent that does not dissolve by itself the substances for the over coat layer according to the present invention may be used, for example, in the case where a mixed solvent with the aforementioned organic solvents can dissolve the substances. In general, the use of a mixed solvent can reduce the coating unevenness. In the case where a dip coating method is used as the coating method described later, it is preferred to select a solvent that does not dissolve the underlayer. From this standpoint, it is preferred to contain an alcohol compound, which has a low solubility to a polycarbonate and a polyarylate used preferably in the photosensitive layer.

The amount ratio of the organic solvent used in the coating liquid for forming the over coat layer of the present invention and the solid content therein may vary depending on the coating method of the coating liquid for forming the over coat layer, and may be used after appropriately changed to form a uniform coated film by the coating method applied.

[Coating Method] The coating method of the coating liquid for forming the over coat layer is not particularly limited, and examples thereof include a spray coating method, a spiral coating method, a ring coating method, and a dip coating method.

After forming the coated film by the coating method, the coated film is dried, the temperature and the period of time of the drying are not particularly limited, as far as necessary and sufficient dryness can be obtained. However, in the case where drying only by air drying is performed after coating photosensitive layer, and the over coat layer is coated, the layers are preferably dried sufficiently by the method described in the section [Coating Method] for the photosensitive layer described above.

Regarding the thickness of the over coat layer, optimum thickness is appropriately selected depending on the materials used and the like, the thickness is preferably 0.1 μm or more, more preferably 0.2 μm or more, and particularly preferably 0.5 μm or more, from the standpoint of the lifetime, and is preferably 10 μm or less, more preferably 5 μm or less, and particularly preferably 3 μm or less, from the standpoint of the electric characteristics.

[Curing Method of the Over Coat Layer] The over coat layer may be formed in such a manner that the coating liquid is coated, and then cured by applying external energy. Examples of the external energy used herein include heat, light, and radiation. The method of applying heat energy may be performed by heating from the side of the coated layer or the side of the support with a gas, such as air and nitrogen, steam, various heat media, an infrared ray, or an electromagnetic wave. The heating temperature is preferably 100° C. or more and 170° C. or less, and at the lower limit temperature or more, sufficient reaction speed is reached, and the reaction proceeds completely. At the upper limit temperature or less, the reaction proceeds uniformly to be able to suppress the occurrence of large distortion in the over coat layer. For performing the curing reaction uniformly, it is also effective to use a method of heating to a relatively low temperature of less than 100° C., and the heating to 100° C. or more to complete the reaction.

As for the light energy, an ultraviolet (UV) radiation light source mainly having a light emission wavelength in UV light, such as a high pressure mercury lamp, a metal halide lamp, an electrodeless lamp bulb, and a light emitting diode, may be used, and a visible light source may also be selected corresponding to the absorption wavelength of the chain polymerizable compound and the photopolymerization initiator. The light radiation dose is preferably 0.1 J/cm² or more, more preferably 0.5 J/cm² or more, and particularly preferably 1 J/cm² or more, from the standpoint of the curability, and is preferably 150 J/cm² or less, more preferably 100 J/cm² or less, and particularly preferably 50 J/cm² or less, from the standpoint of the electric characteristics.

Examples of the energy of radiation include an electron beam (EB).

Among these kinds of energy, light energy is preferred from the standpoint of the easiness in controlling the reaction rate, the convenience of the device, and the range of pot life.

After curing the over coat layer, a heating process may be applied from the standpoint of the relaxation of the residual stress, the relaxation of the residual radicals, and the improvement of the electric characteristics. The heating temperature is preferably 60° C. or more, and more preferably 100° C. or more, and is preferably 200° C. or less, and more preferably 150° C. or less.

[Martens Hardness of Photoreceptor Surface] In the present invention, for example, the single layer type photosensitive layer satisfies the expression (1) and the expression (2) simultaneously, and thereby the hole transporting substance and the electron transporting substance can be secured in numbers that are sufficient for the charge transportation, so as to provide a photoreceptor having good electric characteristics, but on the other hand, in the case where the number of molecules of the hole transporting substance or the electron transporting substance is increased to such an extent in the single layer type photosensitive layer, the number of molecules intervening in the gaps of the polymer chains of the binder resin is also increased to hinder the entanglement of the polymer chains, and consequently, the molecules tend to pass among the polymer chains and to concentrate to the photosensitive layer surface.

However, the present inventors have found that good adhesiveness between the photosensitive layer and the over coat layer can be retained by making the Martens hardness of the photoreceptor surface to 345 N/mm² or more. Furthermore, it has also been found that even though the contents of the hole transporting substance and the electron transporting substance in the photosensitive layer are increased, the similar effect can be obtained by making the Martens hardness of the photoreceptor surface to 350 N/mm² or more.

While the mechanism thereof is being earnestly investigated, it can be estimated that by making the Martens hardness of the photoreceptor surface to 345 N/mm² or more, the cured resin contained in the over coat layer can have a sufficient mechanical strength, and the anchoring effect can be sufficiently exerted at the interface to the single layer type photosensitive layer, resulting in the enhancement of the adhesiveness. More specifically, in the case where the Martens hardness of the photoreceptor surface is less than 345 N/mm², it is considered that the interface between the over coat layer and the single layer type photosensitive layer is soft, and the engagement of the layers at the interface is weak to provide only a weak anchoring effect, resulting in poor adhesiveness of the layers. In the case where the Martens hardness of the photoreceptor surface is 345 N/mm² or more, on the other hand, it is considered that the interface between the over coat layer and the single layer type photosensitive layer is hard, and the engagement of the layers at the interface is strong to provide, resulting in good adhesiveness of the layers. In the case where the Martens hardness of the photoreceptor surface is less than 345 N/mm², it is considered that the poor adhesiveness at the interface between the over coat layer and the single layer type photosensitive layer hinders the delivery of charge at the interface, and thereby the charge transportation from the single layer type photosensitive layer to the over coat layer is hindered to deteriorate the electric characteristics. In the case where the Martens hardness of the photoreceptor surface is 345 N/mm² or more, on the other hand, it is considered that the delivery of charge at the interface can be smoothly performed with the good adhesiveness at the interface between the over coat layer and the single layer type photosensitive layer, and thereby the charge transportation from the single layer type photosensitive layer to the over coat layer can be performed with no delay to provide good electric characteristics.

The Martens hardness of the photoreceptor surface is preferably 350 N/mm² or more, more preferably 370 N/mm² or more, and further preferably 390 N/mm² or more, from the standpoint of the adhesiveness. The Martens hardness of the photoreceptor surface is preferably 600 N/mm² or less, and more preferably 500 N/mm² or less, from the standpoint of the residual stress and the prevention of occurrence of cracks.

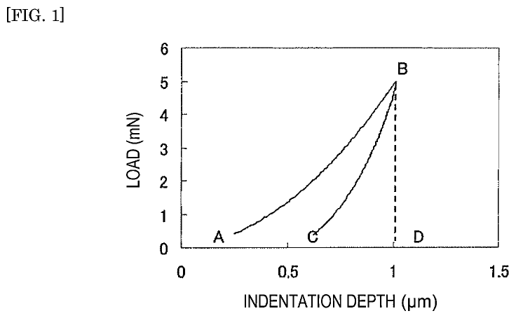

The Martens hardness of the photoreceptor surface can be measured with a microhardness tester, Fischerscope HM2000, available from Helmut Fischer GmbH. In the measurement, a Vickers pyramid diamond indenter having an angle between faces of 136° is used at an optional position of the photoreceptor surface under condition of a temperature of 25° C. and a relative humidity of 50%, and the measurement is performed under the following condition to read continuously the load applied to the indenter and the indentation depth under the load, which are plotted as the Y-axis and the X-axis respectively to provide a profile as shown in FIG. 1.

### Measurement Condition

Maximum indentation load: 0.2 mN

Loading time: 10 seconds

Unloading time: 10 seconds

The Martens hardness is a value defined by the indentation depth according to the following expression.

Martens hardness (N/mm²)=test load (N)/surface area of Vickers indenter under test load (mm²)

### Undercoating Layer

The electrophotographic photoreceptor of the present invention may have an undercoating layer between the photosensitive layer and the conductive support.

Examples of the undercoating layer include a layer containing a resin, or a resin having an organic pigment, metal oxide particles, or the like dispersed therein. Examples of the organic pigment used in the undercoating layer include a phthalocyanine pigment, an azo pigment, a quinacridone pigment, an indigo pigment, a perylene pigment, a polycyclic quinone pigment, an anthanthrone pigment, and a benzimidazole pigment. Specifically, among these, a phthalocyanine pigment and an azo pigment, specifically the phthalocyanine pigment and the azo pigment used as the charge generating substance, are exemplified.

Examples of the metal oxide particles used in the undercoating layer include metal oxide particles containing one kind of a metal element, such as titanium oxide, aluminum oxide, silicon oxide, zirconium oxide, zinc oxide, and iron oxide, and metal oxide particles containing multiple kinds of metal elements, such as calcium titanate, strontium titanate, and barium titanate. For the undercoating layer, only one kind of the particles may be used, or multiple kinds of the particles may be used by mixing as an optional combination at an optional ratio.

Among the metal oxide particles, titanium oxide and aluminum oxide are preferred, and titanium oxide is particularly preferred. The titanium oxide particles may have a surface that is treated with an inorganic material, such as tin oxide, aluminum oxide, antimony oxide, zirconium oxide, and silicon oxide, or an organic material, such as stearic acid, a polyol, and a silicone. The crystal form of titanium oxide particles may be any of rutile, anatase, brookite, and amorphous. Multiple kinds of crystal states from these crystal states may be contained.

The particle diameter of the metal oxide particles used in the undercoating layer is not particularly limited, is preferably 10 nm or more, and is preferably 100 nm or less, and more preferably 50 nm or less, in terms of average primary particle diameter, from the standpoint of the characteristics of the undercoating layer and the stability of the solution for forming the undercoating layer.

The undercoating layer is preferably formed in the form containing the particles dispersed in a binder resin. The binder resin used in the undercoating layer may be selected, for example, from an insulating resin, for example, a polyvinyl butyral resin, a polyvinyl formal resin, a polyvinyl acetal based resin, such as a partially acetalized polyvinyl butyral resin in which a part of butyral is modified with formal, acetal, or the like, a polyarylate resin, a polycarbonate resin, a polyester resin, a modified ether based polyester resin, a phenoxy resin, a polyvinyl chloride resin, a polyvinylidene chloride resin, a polyvinyl acetate resin, a polystyrene resin, an acrylic resin, a methacrylic resin, a polyacrylamide resin, a polyamide resin, a polyvinylpyridine resin, a cellulose based resin, a polyurethane resin, an epoxy resin, a silicone resin, a polyvinyl alcohol resin, a polyvinylpyrrolidone resin, casein, a vinyl chloride-vinyl acetate based copolymer, such as a vinyl chloride-vinyl acetate copolymer, a hydroxy-modified vinyl chloride-vinyl acetate copolymer, a carboxy-modified vinyl chloride-vinyl acetate copolymer, and a vinyl chloride-vinyl acetate-maleic anhydride copolymer, a styrene-butadiene copolymer, a vinylidene chloride-acrylonitrile copolymer, a styrene-alkyd resin, silicone-alkyd resin, and a phenol-formaldehyde resin, and an organic photoconductive polymer, such as poly-N-vinylcarbazole, polyvinylanthracene, and polyvinylperylene, but there is not limitation to the polymers. The binder resin may be used alone, or two or more kinds thereof may be used by mixing, and may be used after curing with a curing agent. Among these, a polyvinyl butyral resin, a polyvinyl formal resin, a polyvinyl acetal based resin, such as a partially acetalized polyvinyl butyral resin in which a part of butyral is modified with formal, acetal, or the like, an alcohol soluble copolymer polyamide, and a modified polyamide are preferred since good dispersibility and coatability are exhibited thereby.

The mixing ratio of the particles with respect to the binder resin may be optionally selected, and is preferably in a range of 10% by mass to 500% by mass from the standpoint of the stability and the coatability of the dispersion liquid. The film thickness of the undercoating layer may be optionally selected, and is generally preferably 0.1 μm or more and 20 μm or less from the standpoint of the characteristics of the electrophotographic photoreceptor and the coatability of the dispersion liquid. The undercoating layer may contain a known antioxidant and the like.

### Additional Layer

The electrophotographic photoreceptor of the present invention may appropriately include an additional layer depending on necessity, in addition to the conductive support, the photosensitive layer, the over coat layer, and the undercoating layer described above.

### EXAMPLES

The embodiments of the present invention will be described more specifically with reference to examples below. However, the examples shown below are shown for describing the present invention in detail, and the present invention is not limited to the examples shown below and can be practiced with optional modifications unless the substance of the present invention is deviated. In Examples and Comparative Examples below, the “part” shows “part by mass” unless otherwise indicated.

### Example 1 <Production of Single Layer Type Photoreceptor>

A single layer type photoreceptor was produced in the following procedure.

### Formation of Undercoating Layer

20 parts of D-type titanyl phthalocyanine showing a clear peak at 27.3° of diffraction angle 2θ±0.2° in powder X-ray diffraction using the CuKα ray and 280 parts of 1,2-dimethoxyethane were mixed and ground with a sand grinder mill for 2 hours to provide a dispersion liquid. Subsequently, 400 parts of a 2.5% 1,2-dimethoxyethane solution of polyvinyl butyral (“Denka Butyral” #6000C, a trade name, available from Denka Co., Ltd.) and 170 parts of 1,2-dimethoxyethane were mixed with the dispersion liquid to produce a coating liquid for forming an undercoating layer. The coating liquid was coated on an aluminum plate (conductive support) having a thickness of 0.3 mm with a wire bar to make a film thickness of 0.4 μm after drying, followed by air drying, so as to form an undercoating layer.

### Formation of Single Layer Type Photosensitive Layer

2.6 parts of D-type titanyl phthalocyanine showing a clear peak at 27.3° of diffraction angle 2θ±0.2° in powder X-ray diffraction using the CuKα line, 1.3 parts of a perylene pigment 1 having the following structure, 60 parts of the hole transporting substance (HTM48), 50 parts of the electron transporting substance (ET-2), 100 parts of the following binder resin 1, and 0.05 part of a silicone oil (KF-96, a trade name, available from Shin-Etsu Silicone Co., Ltd.) as a leveling agent were mixed with 974 parts of a mixed solvent of tetrahydrofuran (which may be hereinafter abbreviated as THF) and toluene (which may be hereinafter abbreviated as TL) (THF: 80% by mass, TL: 20% by mass), so as to produce a coating liquid for forming the single layer type photosensitive layer. The coating liquid was coated on the undercoating layer with a bar coater to make a film thickness of approximately 20 μm after drying, followed by drying at 100° C. for 20 minutes, so as to form a single layer type photosensitive layer.

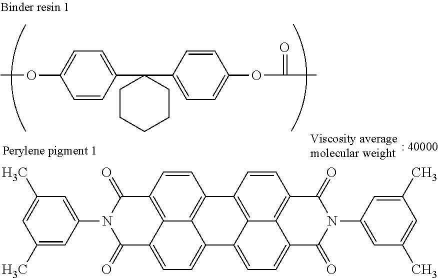

### Formation of Over Coat Layer

100 parts of a urethane acrylate, UV7600B (available from Mitsubishi Chemical Corporation), 55 parts of titanium oxide particles having been surface-treated with 3-methacryloyloxypropyl trimethoxysilane in an amount of 7% by mass with respect to the particles (TTO55N, available from Ishihara Sangyo Kaisha), and 1 part of benzophenone and 2 parts of diphenyl(2,4,6-trimethylbenzoyl)phosphine oxide as photopolymerization initiators were mixed with 745 parts of a mixed solvent of methanol, 1-propanol, and toluene (methanol: 70% by mass, 1-propanol: 10% by mass, toluene: 20% by mass), so as to produce a coating liquid for forming an over coat layer. The coating liquid was coated on the single layer type photosensitive layer with a bar coater to make a film thickness of 1 μm after drying, followed by heating to 125° C. for 20 minutes. The coated film was irradiated from the front surface side thereof with UV light to a cumulative light amount of 25.5 J/cm² with an UV light irradiation device equipped with an UV-LED lamp having a peak at a wavelength of 385 nm. Furthermore, the coated film was heated to 125° C. for 10 minutes and then spontaneously cooled to 25° C., so as to form an over coat layer.

### Examples 2 to 21 and Comparative Examples 1 to 71

The photoreceptors of Examples 2 to 21 and Comparative Examples 1 to 7 were produced in the same procedure as in Example 1 except that the hole transporting substance and the electron transporting substance used in the single layer type photosensitive layer and the contents thereof, and the compound having a chain polymerizable functional group used in the over coat layer were changed as shown in Tables 1 and 2.

### Electric Characteristics Test

With EPA 8200, available from Kawaguchi Electric Works Co., Ltd., the photoreceptors obtained in Examples and Comparative Examples each were charged positively by applying a current of +30 μA to the scorotron charger, and the surface potential thereof was designated as V0 (+V). The charged photoreceptor was irradiated for 10 seconds with monochromatic light of 55 nw obtained by passing light of a halogen lamp through a monochromatic filter of 780 nm. The surface potential at this time was designated as be Vr (+V), and the half decay exposure where the surface potential was decayed from V0 to half of V0 was designated as a sensitivity E1/2 (μJ/cm²). The retention rate of the surface potential after allowing the charged photoreceptor to stand in the dark for 5 seconds was designated as DDR-5 (%). The measurement environment was a temperature of 25° C. and a relative humidity of 50%. A smaller absolute value of Vr shows a photoreceptor having a smaller residual potential and better electric characteristics. A smaller absolute value of E1/2 shows a photoreceptor having a better sensitivity to light. The results are shown in Tables 1 and 2.

### Martens Hardness of Photoreceptor Surface

The Martens hardness and the elastic deformation rate of the photoreceptor surface were measured with a microhardness tester, Fischerscope HM2000, available from Helmut Fischer GmbH under an environment of a temperature of 25° C. and a relative humidity of 50%. A Vickers pyramid diamond indenter having an angle between faces of 136° was used for the measurement. The measurement was performed under the condition set to the following, and the load applied to the indenter and the indentation depth under the load were continuously read and plotted as the Y-axis and the X-axis respectively to provide a profile as shown in FIG. 1. In applying a load to the indenter, the state A transferred to the state B in FIG. 1, and in removing the load to the indenter, the state B transferred to the state C in FIG. 1. The results are shown in Tables 1 and 2.

### Measurement Condition

Maximum indentation load: 0.2 mN

Loading time: 10 seconds

Unloading time: 10 seconds

The Martens hardness is a value defined by the indentation depth according to the following expression.

Martens hardness (N/mm²)=test load (N)/surface area of Vickers indenter under test load (mm²)

The elastic deformation rate is a value defined according to the following expression, and means the ratio of the work performed through the elasticity of the film in unloading with respect to the total work required for the indentation.

Elastic deformation rate (%)=(We/Wt)×100

In the expression, the total work Wt (nJ) is the area surrounded by A-B-D-A in FIG. 1, and the elastic deformation work We (nJ) is the area surrounded by C-B-D-C in FIG. 1. A larger elastic deformation rate means that the deformation on the load is harder to remain, and the case where the elastic deformation rate is 100 means that no deformation remains.

### Adhesiveness Test

On each of the single layer type photoreceptors produced in Examples and Comparative Examples, 6 lengthwise cut lines and 6 crosswise cut lines were formed with an interval of 2 mm using NT Cutter (available from NT Inc.) to produce 5×5=25 squares. A cellophane adhesive tape (available from 3M Company) was adhered thereon, and then withdrawn in the direction at 90° with respect to the adhered surface, so as to evaluate the adhesiveness between the photosensitive layer and the over coat layer. The ratio of the number of the squares of the over coat layer remaining on the photosensitive layer was evaluated as the residual ratio. A larger number of the residual squares means a higher residual ratio, which shows better adhesiveness. In all the tests, no peeling was observed between the aluminum plate as the support and the photosensitive layer, and in the case where peeling occurred, the peeling occurred around the interface between the photosensitive layer and the over coat layer in all the cases. The results are shown in Tables 1 and 2.

TABLE 1

| | | | | | | | | | | | | Evaluation | | | |
|---|---|---|---|---|---|---|---|---|---|---|---|---|---|---|---|
| | | | | | | | | | | Over coat layer | | Elastic | | | |
| | | Photosensitive layer | | | | | | | | Compound | Martens | deformation | | | |
| | | Hole | | | Electron | | | | | having chain | hardness of | rate of | | | |
| | | trans- | | | trans- | | | | | polymerizable | photo- | photo- | | | Adhe- |
| | | porting | | | porting | | | (B/b)/ | (A/a) + | functional | receptor | receptor | | | sive- |
| | | substance | a | A | substance | b | B | (A/a) | (B/b) | group | surface | surface | E½ | Vr | ness |
| Example | 1 | HTM48 | 748 | 60 | ET-2 | 424.2 | 50 | 1.47 | 0.20 | UV7600B | 406 | 47 | 0.12 | 12 | 100 |
| | 2 | HTM48 | 748 | 60 | ET-2 | 424.2 | 40 | 1.18 | 0.17 | UV7600B | 398 | 46 | 0.14 | 13 | 100 |
| | 3 | HTM48 | 748 | 60 | ET-2 | 424.2 | 31 | 0.91 | 0.15 | UV7600B | 383 | 46 | 0.15 | 20 | 100 |
| | 4 | HTM48 | 748 | 40 | ET-2 | 424.2 | 50 | 2.20 | 0.17 | UV7600B | 366 | 47 | 0.11 | 12 | 100 |
| | 5 | HTM48 | 748 | 35 | ET-2 | 424.2 | 50 | 2.52 | 0.16 | UV7600B | 386 | 48 | 0.11 | 13 | 100 |
| | 6 | HTM48 | 748 | 30 | ET-2 | 424.2 | 50 | 2.94 | 0.16 | UV7600B | 404 | 52 | 0.11 | 15 | 100 |
| | 7 | HTM48 | 748 | 25 | ET-2 | 424.2 | 50 | 3.53 | 0.15 | UV7600B | 389 | 47 | 0.13 | 18 | 100 |
| | 8 | HTM48 | 748 | 90 | ET-2 | 424.2 | 50 | 0.98 | 0.24 | UV7600B | 403 | 49 | 0.16 | 21 | 100 |
| | 9 | HTM40 | 776.4 | 60 | ET-2 | 424.2 | 50 | 1.53 | 0.20 | UV7600B | 447 | 54 | 0.12 | 12 | 100 |
| | 10 | HTM42 | 700.4 | 60 | ET-2 | 424.2 | 50 | 1.38 | 0.20 | UV7600B | 460 | 58 | 0.12 | 11 | 100 |
| | 11 | HTM43 | 700.4 | 60 | ET-2 | 424.2 | 50 | 1.38 | 0.20 | UV7600B | 447 | 52 | 0.12 | 10 | 100 |
| | 12 | HTM6 | 552.3 | 60 | ET-2 | 424.2 | 50 | 1.08 | 0.23 | UV7600B | 453 | 52 | 0.13 | 15 | 100 |
| | 13 | HTM26 | 451.6 | 60 | ET-2 | 424.2 | 50 | 0.89 | 0.25 | UV7600B | 432 | 49 | 0.13 | 13 | 100 |
| | 14 | HTM48 | 748 | 60 | ET-2 | 424.2 | 50 | 1.47 | 0.20 | UV1700B | 391 | 52 | 0.12 | 12 | 12 |
| | 15 | HTM48 | 748 | 60 | ET-2 | 424.2 | 50 | 1.47 | 0.20 | A-DPH | 429 | 49 | 0.13 | 14 | 100 |
| | 16 | HTM48 | 748 | 60 | ET-2 | 424.2 | 50 | 1.47 | 0.20 | A-TMPT | 413 | 40 | 0.13 | 15 | 100 |
| | 17 | HTM48 | 748 | 60 | ET-2 | 424.2 | 50 | 1.47 | 0.20 | 1/1 mixture | 390 | 50 | 0.12 | 10 | 100 |
| | | | | | | | | | | of UV6300B | | | | | |
| | | | | | | | | | | and A-DPH | | | | | |
| | 18 | HTM48 | 748 | 90 | ET-2 | 424.2 | 35 | 0.69 | 0.20 | UV6300B | 349 | 50 | 0.17 | 27 | 12 |
| | 19 | HTM48 | 748 | 60 | ET-2 | 424.2 | 25 | 0.73 | 0.14 | UV7600B | 426 | 49 | 0.17 | 35 | 100 |
| | 20 | HTM48 | 748 | 60 | ET-2 | 424.2 | 20 | 0.59 | 0.13 | UV7600B | 413 | 51 | 0.18 | 56 | 100 |
| | 21 | HTM10 | 475.2 | 60 | ET-2 | 424.2 | 40 | 0.75 | 0.22 | UV7600B | 393 | 44 | 0.15 | 27 | 100 |

TABLE 2

| | | | | | | | | | | | | Evaluation | | | |
|---|---|---|---|---|---|---|---|---|---|---|---|---|---|---|---|
| | | | | | | | | | | Over coat layer | | Elastic | | | |
| | | Photosensitive layer | | | | | | | | Compound | Martens | deformation | | | |
| | | Hole | | | Electron | | | | | having chain | hardness of | rate of | | | |
| | | trans- | | | trans- | | | | | polymerizable | photo- | photo- | | | Adhe- |
| | | porting | | | porting | | | (B/b)/ | (A/a) + | functional | receptor | receptor | | | sive- |
| | | substance | a | A | substance | b | B | (A/a) | (B/b) | group | surface | surface | E½ | Vr | ness |
| Comparative | 1 | HTM48 | 748 | 90 | ET-2 | 424.2 | 50 | 0.98 | 0.24 | UV6300B | 303 | 43 | 0.20 | 23 | 0 |
| Example | 2 | HTM48 | 748 | 60 | ET-2 | 424.2 | 50 | 1.47 | 0.20 | UV6300B | 327 | 46 | 0.12 | 12 | 0 |
| | 3 | HTM48 | 748 | 40 | ET-2 | 424.2 | 50 | 2.20 | 0.17 | UV6300B | 330 | 48 | 0.11 | 12 | 0 |
| | 4 | HTM48 | 748 | 60 | ET-2 | 424.2 | 50 | 1.47 | 0.20 | UV7610B | 340 | 46 | 0.12 | 12 | 0 |
| | 5 | HTM48 | 748 | 60 | ET-2 | 424.2 | 50 | 1.47 | 0.20 | UV7550B | 255 | 32 | 0.12 | 22 | 0 |
| | 6 | HTM48 | 748 | 90 | ET-2 | 424.2 | 20 | 0.39 | 0.17 | UV6300B | 337 | 55 | 0.20 | 71 | 16 |
| | 7 | HTM48 | 748 | 60 | ET-2 | 424.2 | 20 | 0.59 | 0.13 | UV6300B | 338 | 52 | 0.16 | 69 | 40 |

### Measurement Results

It is understood from the results shown in Tables 1 and 2 that in the case where the over coat layer has a structure formed through polymerization of a compound having a chain polymerizable functional group, and the photoreceptor having a surface having a Martens hardness of 345 N/mm² or more, the residual potential Vr is small, and the number of squares remaining in the adhesiveness test is large. Accordingly, it is understood that a photoreceptor excellent in electric characteristics mechanical characteristics and in adhesiveness between the photosensitive layer and the over coat layer is obtained. On the other hand, it is understood therefrom that in Comparative Examples, due to the low Martens hardness of the photoreceptor surface, the residual potential Vr is large, or the result of the adhesiveness test is poor.

1. A positively charging electrophotographic photoreceptor comprising a conductive support having thereon at least a photosensitive layer and an over coat layer,
wherein the photosensitive layer is a single layer containing at least a binder resin, a charge generating substance, a hole transporting substance, and an electron transporting substance,
the over coat layer has a structure formed through polymerization of a compound having a chain polymerizable functional group,
a surface of the positively charging electrophotographic photoreceptor has a Martens hardness of 345 N/mm² or more.

2. The positively charging electrophotographic photoreceptor according to claim 1, wherein the photosensitive layer satisfies the following expression (1):
0.9≤(B/b)/(A/a)≤4.0 (1)
wherein in the expression (1),
A represents a content (part by mass) of the hole transporting substance per a content of 100 of the binder resin;
a represents a molecular weight of the hole transporting substance;
B represents a content (part by mass) of the electron transporting substance per a content of 100 of the binder resin; and
b represents a molecular weight of the electron transporting substance.

3. The positively charging electrophotographic photoreceptor according to claim 1, wherein the photosensitive layer satisfies the following expression (2):
0.15≤(A/a)+(B/b) (2)
wherein in the expression (2),
A represents a content (part by mass) of the hole transporting substance per a content of 100 of the binder resin;
a represents a molecular weight of the hole transporting substance;
B represents a content (part by mass) of the electron transporting substance per a content of 100 of the binder resin; and
b represents a molecular weight of the electron transporting substance.

4. A positively charging electrophotographic photoreceptor comprising a conductive support having thereon at least a photosensitive layer and an over coat layer,
wherein the photosensitive layer is a single layer containing at least a binder resin, a charge generating substance, a hole transporting substance, and an electron transporting substance,
the photosensitive layer satisfies the following expression (1) and the following expression (2),
the over coat layer has a structure formed through polymerization of a compound having a chain polymerizable functional group, the photoreceptor having a surface having a Martens hardness of 350 N/mm² or more:
0.9≤(B/b)/(A/a)≤4.0 (1)
0.15≤(A/a)+(B/b) (2)
wherein in the expression (1) and the expression (2),
A represents a content (part by mass) of the hole transporting substance per a content of 100 of the binder resin;
a represents a molecular weight of the hole transporting substance;
B represents a content (part by mass) of the electron transporting substance per a content of 100 of the binder resin; and
b represents a molecular weight of the electron transporting substance.

5. The positively charging electrophotographic photoreceptor according to claim 1, wherein the over coat layer contains metal oxide fine particles.

6. The positively charging electrophotographic photoreceptor according to claim 5, wherein the metal oxide fine particles are surface-treated with a surface treatment agent having a polymerizable functional group.

7. The positively charging electrophotographic photoreceptor according to claim 1, wherein the photosensitive layer contains the hole transporting substance having a molecular weight of 700 or more.

8. The positively charging electrophotographic photoreceptor according to claim 1, wherein the compound having a chain polymerizable functional group contains a compound having two or more chain polymerizable functional groups.

9. The positively charging electrophotographic photoreceptor according to any one of claim 1, wherein the compound having a chain polymerizable functional group contains a compound having an acryloyl group or a methacryloyl group.

10. The electrophotographic photoreceptor according to claim 1, wherein the compound having a chain polymerizable functional group contains an urethane acrylate.

11. The positively charging electrophotographic photoreceptor according to claim 1, wherein the electron transporting substance has a molecular weight of 400 or more.

12. The positively charging electrophotographic photoreceptor according to claim 1, wherein the electron transporting substance contained in the photosensitive layer is a compound represented by any one of the following formulae (7) to (10): 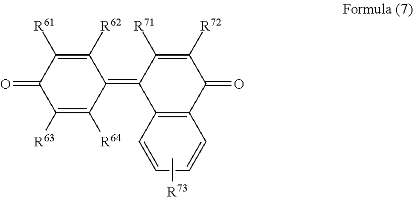
wherein in the formula (7), R⁷¹ to R⁷³ each independently represent a hydrogen atom, a halogen atom, or an alkyl group having 1 or more and 6 or less carbon atoms; 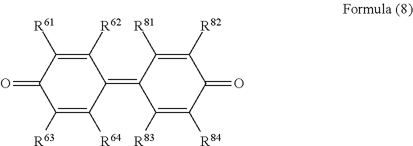
wherein in the formula (8), R⁸¹ to R⁸⁴ each independently represent a hydrogen atom, a halogen atom, or an alkyl group having 1 or more and 6 or less carbon atoms; 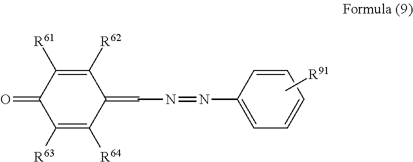
wherein in the formula (9), R⁹¹ represents a hydrogen atom, an alkyl group having 1 or more and 6 or less carbon atoms, or a halogen atom; 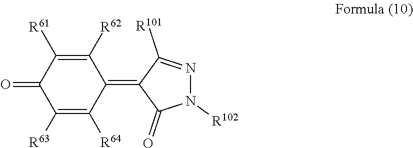
wherein in the formula (10), R¹⁰¹ and R¹⁰² each independently represent a hydrogen atom, a halogen atom, an alkyl group having 1 or more and 6 or less carbon atoms, or an aryl group having 6 or more and 12 or less carbon atoms.

13. An electrophotographic photoreceptor cartridge comprising the positively charging electrophotographic photoreceptor according to claim 1.

14. An image formation device comprising the positively charging electrophotographic photoreceptor according to claim 1.

15. The positively charging electrophotographic photoreceptor according to claim 12, wherein R⁶¹ to R⁶⁴ each independently represent a hydrogen atom, a substituted or unsubstituted alkyl group having 1 or more and 20 or less carbon atoms, or a substituted or unsubstituted alkenyl group having 2 or more and 20 or less carbon.

16. The positively charging electrophotographic photoreceptor according to claim 12, wherein R⁶¹ to R⁶⁴ each independently represent a hydrogen atom, an unsubstituted alkyl group having 1 or more and 20 or less carbon atoms, or an unsubstituted alkenyl group having 2 or more and 20 or less carbon.

17. The positively charging electrophotographic photoreceptor according to claim 12, wherein R⁶¹ and R⁶², or R⁶³ and R⁶⁴ are bonded to each other to form a cyclic structure.
